(19) United States
(12) Patent Application Publication
(10) Pub. No.: US 2024/0386617 A1
(43) Pub. Date: Nov. 21, 2024

(54) ENCODING METHOD, DECODING METHOD, AND DECODER

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Ming LI, Dongguan (CN)

(21) Appl. No.: 18/788,030

(22) Filed: Jul. 29, 2024

Related U.S. Application Data
(63) Continuation of application No. PCT/CN2022/075269, filed on Jan. 30, 2022.

(51) Int. Cl. G06T 9/40

(52) U.S. Cl. CPC G06T 9/40

(57) ABSTRACT

A decoding method is applicable to a decoder and includes the following. A planar mode enable flag of a point cloud and geometry encoding information of the point cloud are determined. During decoding of geometry encoding information of a node in a current node-layer, the node in the current node-layer is decoded using a planar decoding mode when a planar mode enable flag corresponding to a level of the current node-layer is a first preset value.

### CROSS-REFERENCE TO RELATED APPLICATION(S)

This application is a continuation of International Application No. PCT/CN2022/075269, filed Jan. 30, 2022, the entire disclosure of which is hereby incorporated by reference.

### TECHNICAL FIELD

Embodiments of the disclosure relate to the technical field of point cloud coding, and in particular to an encoding method, a decoding method, and a decoder.

### BACKGROUND

With the continuous development of point cloud technology, compression encoding of point cloud data becomes an important research problem. At present, both the audio video coding standard workgroup of China (AVS) and the moving picture experts group (MPEG) of international standardization organization (ISO) are developing point cloud coding standards, such as geometry-based point cloud compression (G-PCC). How to further improve performance of point cloud coding is an urgent problem to be solved. In a G-PCC encoder framework, geometry information of a point cloud is encoded separately from attribute information corresponding to the point cloud. Once the geometry information has been encoded, the geometry information is reconstructed, based on which the attribute information is encoded.

Currently, during octree-based geometry information coding, the bounding box is octeted into 8 sub-cubes and occupancy bits of the sub-cubes are recorded (where 1 represents non-empty and 0 represents empty). The non-empty sub-cubes are continued to be octeted, generally until a resulting leaf node is a 1×1×1 unit cube. In this process, spatial correlation between a node and the surrounding nodes is used for intra prediction of the occupancy bits, and finally context-based adaptive binary arithmetic coding (CABAC) is performed to generate a binary bitstream. During the process of generating the binary bitstream by CABAC, it is necessary to determine whether the current node is eligible enough for a planar coding mode, which is mainly determined by considering whether a local occupancy density of the node is greater than a preset threshold and whether a proportion of nodes for which the planar coding mode in a certain direction (x, y, or z) is used is greater than a corresponding preset threshold (three directions, i.e., the x direction, the y direction, and the z direction, each correspond to one threshold).

However, the real-time updating of the two variables, i.e., the local occupancy density of the node and the proportion of the nodes for which the planar coding mode is used, causes substantial computation complexity. In addition, multiple threshold settings increase the difficulty of optimization, which prevents better utilization of the planar coding mode to get more coding gains.

### SUMMARY

In a first aspect, a decoding method is provided in embodiments of the disclosure. The method is applied to a decoder and includes the following. A planar mode enable flag of a point cloud and geometry encoding information of the point cloud are determined. During decoding of geometry encoding information of a node in a current node-layer, the node in the current node-layer is decoded using a planar decoding mode when a planar mode enable flag corresponding to a level of the current node-layer is a first preset value.

In a second aspect, an encoding method is provided in embodiments of the disclosure. The method is applied to an encoder and includes the following. Geometry information of a point cloud is obtained. Planar-encoding-mode eligibility corresponding to a current node-layer corresponding to the geometry information is determined. When the planar-encoding-mode eligibility corresponding to the current node-layer is a third preset value, it is determined that a node in the current node-layer is encoded using a planar encoding mode, and a planar mode enable flag corresponding to a level of the current node-layer is generated.

In a third aspect, a decoder is provided in embodiments of the disclosure. The decoder includes a first memory and a first processor. The first memory is configured to store computer programs that are executable on the first processor. The first processor is configured to perform the method in the first aspect when executing the computer programs.

### BRIEF DESCRIPTION OF THE DRAWINGS

FIG. 1 is a schematic diagram illustrating an exemplary octree structure provided in embodiments of the disclosure.

FIG. 2 is a schematic diagram illustrating cubes of an exemplary octree structure provided in embodiments of the disclosure.

FIG. 3 is a block diagram illustrating a process of geometry-based point cloud compression (G-PCC) encoding provided in embodiments of the disclosure.

FIG. 4 is a block diagram illustrating a process of G-PCC decoding provided in embodiments of the disclosure.

FIG. 5A is a flowchart illustrating a decoding method provided in embodiments of the disclosure.

FIG. 5B is a flowchart illustrating a decoding method provided in embodiments of the disclosure.

FIG. 6 is a flowchart illustrating an encoding method provided in embodiments of the disclosure.

FIG. 7 is a flowchart illustrating an encoding method provided in embodiments of the disclosure.

FIG. 8 is a flowchart illustrating a decoding method provided in embodiments of the disclosure.

FIG. 9 is a schematic structural diagram illustrating a decoder provided in embodiments of the disclosure.

FIG. 10 is a schematic diagram illustrating a hardware structure of a decoder provided in embodiments of the disclosure.

FIG. 11 is a schematic structural diagram illustrating an encoder provided in embodiments of the disclosure.

FIG. 12 is a schematic diagram illustrating a hardware structure of an encoder provided in embodiments of the disclosure.

### DETAILED DESCRIPTION

To understand features and technical content of embodiments of the disclosure in detail, the following describes embodiments of the disclosure in detail with reference to accompanying drawings, which are provided for illustrative purposes only and are not intended to limit the disclosure.

The disclosure is applicable to the technical field of point cloud data compression. First, related terms in embodiments of the disclosure will be explained.

1) Point cloud, which is a three-dimensional (3D) representation of a surface of an object and refers to a collection of massive amounts of 3D points. Each point has associated attributes, such as colour, material properties, etc. Exemplarily, point clouds can be used to reconstruct an object or a scene as a composition of points. A point in the point cloud may have both geometry information and attribute information of the point. As an example, the geometry information of the point may be 3D coordinate information of the point, which may be represented by, for example, (x, y, z) in the Cartesian coordinate system or any coordinate system. The geometry information of the point may also be referred to as location information of the point. As an example, these points may have associated attribute information such as colour, for example, three component values of red-green-blue (RGB) or luminance-chrominance (YUV). Other attribute information may include transparency, reflectance, a normal vector, etc., which is not limited herein.

The point cloud may be static or dynamic. For example, static point cloud data may be generated by a detailed scan or mapping of an object or topography, and dynamic point cloud data may be generated by scanning an environment for machine-vision purposes. Since the dynamic point cloud data changes over time, the dynamic point cloud may be a time-ordered sequence of point clouds.

The point cloud can be applied to various fields, such as virtual/augmented reality, machine vision, geographic information systems, medical fields, and the like. The point cloud of the surface of the object can be captured by a capturing equipment such as a photoelectric radar, LIDAR, a laser scanner, and a multi-view camera. The point cloud contains a large number of points, for example, billions of points, and thus the original data volume of the point cloud is particularly enormous. Therefore, an effective compression technology, i.e., encoding and decoding process, is required to reduce the data volume of the point cloud.

2) Tree structure for the point cloud, which may represent a partition result of geometry information of the point cloud during encoding or decoding of the point cloud. In the tree structure-based point cloud partition process, a volumetric space for the point cloud is recursively split into sub-volumes, accordingly, the volumetric space corresponds to a root node in the tree structure, and the sub-volumes correspond to nodes of the tree structure respectively. Exemplarily, whether to further split a sub-volume may be determined based on whether the sub-volume contains a point. Each node may have an occupancy bit which indicates whether a sub-volume corresponding to that node contains a point. Optionally, arithmetic encoding may be performed on these occupancy bits to obtain a binary bitstream.

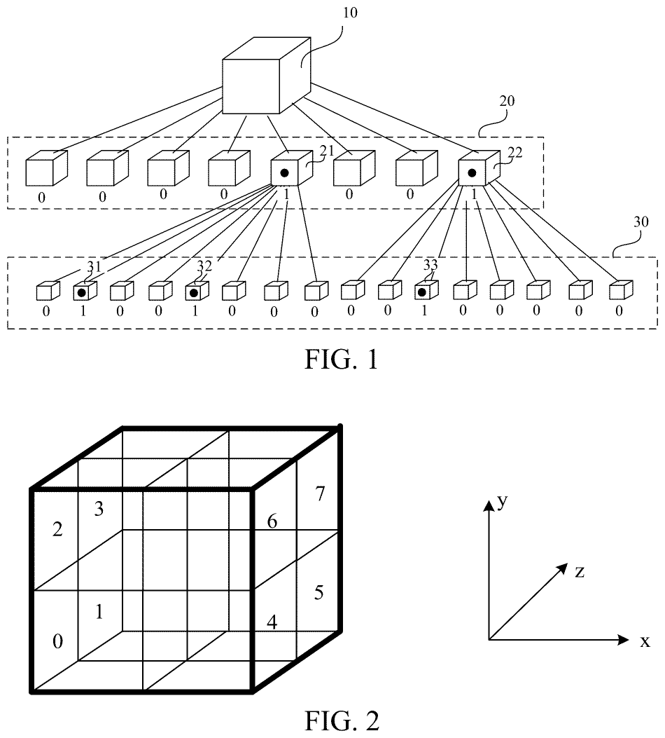

As an example, the tree structure may be an octree. In the octree structure for the point cloud, the volumetric space or sub-volumes are all cubes, and each split results in eight further sub-volumes/sub-cubes. FIG. 1 is a schematic diagram of an octree structure. As illustrated in FIG. 1, a node 10 may be a root node and may correspond to a volumetric space, for example, a cube, of a complete point cloud. The volumetric space corresponding to the node 10 may be split into 8 sub-volumes, each of which corresponds to one of nodes in the dashed box 20. The node 10 is a parent node of the nodes in the dashed box 20, accordingly, the nodes in the dashed box 20 are child nodes of the node 10, and the child nodes may be called sibling nodes of each other. As illustrated in FIG. 1, the child nodes of the node 10 (i.e., the nodes in the dashed box 20) may include a node containing a point, and an occupancy bit of the node is 1, which indicates that a sub-volume corresponding to that node contains a point. In some embodiments, a node whose occupancy bit is 1 may also be referred to as an occupied node, which is not limited in the disclosure. The child nodes of the node 10 may further include a node containing no point, and an occupancy bit of the node is 0, which indicates that a sub-volume corresponding to that node contains no point, i.e., the sub-volume is empty. The parent node may be represented by occupancy bits of its child nodes. For example, the node 10 may be represented in a binary form of “00001001”, which indicates that the occupancy bits of child node 21 and child node 22 are 1.

Exemplarily, a sub-volume corresponding to each of nodes whose occupancy bits are 1 in the dashed box 20, such as node 21 and node 22, may be split into 8 further sub-volumes. Correspondingly, the node 21 is a parent node of nodes corresponding to the 8 further sub-volumes that are split from the sub-volume corresponding to the node 21, and the node 22 is a parent node of nodes corresponding to the 8 further sub-volumes that are split from the sub-volume corresponding to the node 22. The 8 further sub-volumes obtained by splitting are child nodes, for example, respective nodes in the dashed box 30. Similarly, the node 21 may be represented by “01001000” in a binary form, which indicates that the occupancy bits of child node 31 and child node 32 are 1. The node 22 may be represented by “001000000” in a binary form, which indicates that the occupancy bit of child node 33 is 1. Optionally, arithmetic encoding may be performed on these occupancy bits to obtain a binary bitstream.

In some optional embodiments, the node 10 may also be a node corresponding to a sub-volume, that is, the octree structure in FIG. 1 may be a part of the octree structure corresponding to the complete point cloud, which is not limited in the disclosure.

In some optional embodiments, nodes having the same depth in the octree structure may form one node-layer. The octree structure may have at least two node-layers, each node-layer may include at least one node, and each node may correspond to one sub-volume.

As an example, as illustrated in FIG. 1, when the node 10 is the root node, all the nodes in the dashed box 20 have a depth value of 1 and belong to one node-layer, where the node-layer may be referred to as “layer” for short. Exemplarily, the node-layer corresponding to the dashed box 20 may be the 0-th layer of the octree structure. Similarly, all the nodes in the dashed box 30 have a depth value of 2 and belong to one node-layer. Exemplarily, the node-layer corresponding to the dashed box 30 may be the 1st layer of the octree structure. When sub-volumes corresponding to the nodes in the dashed box 30 are further split, the octree structure may have nodes of greater depths, which correspond to more node-layers. With an increase in the depth value of nodes, a layer number of a node-layer increases successively.

3) Context modelling, by which context information corresponding to each node of the octree structure can be obtained. FIG. 2 is a schematic diagram of spatial locations of 8 child nodes (i.e., child nodes 0 to 7), which are generated by octree partitioning, relative to their parent node (i.e., a current node). When an 8-bit spatial occupancy code is encoded for the current node, reference information of neighbours in the same layer can be obtained, for example, including occupancy information of neighbouring child nodes in the left, front, and downward directions (such as negative directions of x, y, and z axes in the coordinate system). Exemplarily, for each of child nodes at different locations of the current node, at least one of three coplanar neighbours, three collinear neighbours, or one co-vertex neighbour in the same layer as the child node may be used as a reference node. For a to-be-encoded node, occupancy status of reference nodes in the same layer as the to-be-encoded node may each correspond to one context information.

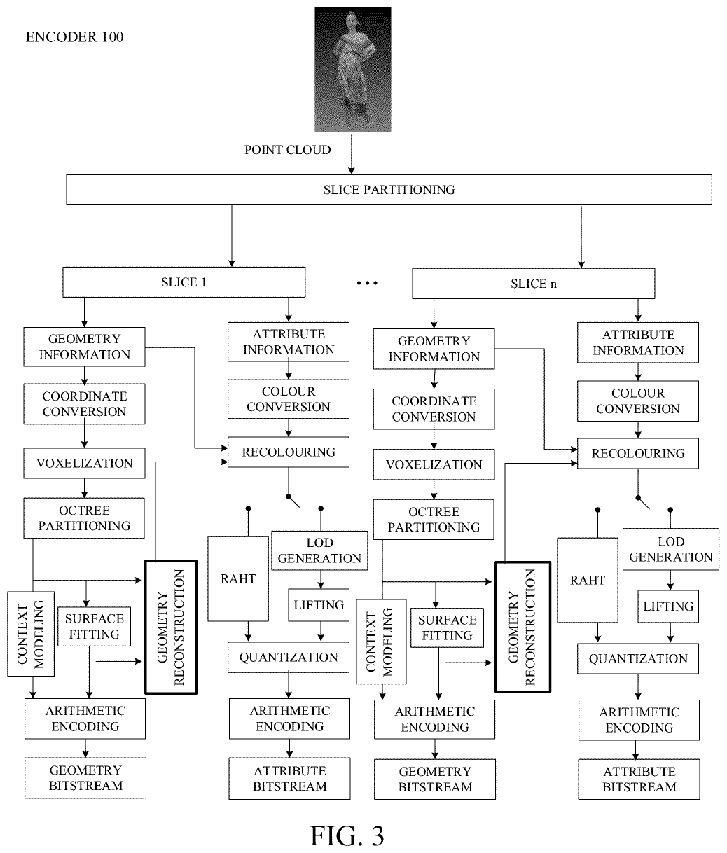

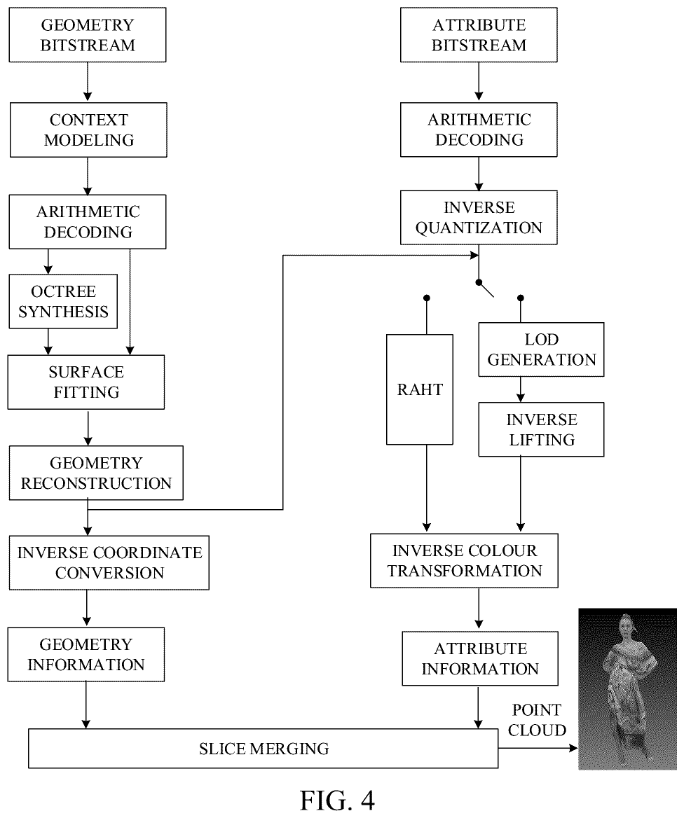

A coding framework for point cloud compression to which embodiments of the disclosure are applicable is described below with reference to FIG. 3 and FIG. 4.

FIG. 3 is a block diagram illustrating a process of geometry-based point cloud compression (G-PCC) encoding provided in embodiments of the disclosure. Exemplarily, FIG. 3 illustrates an encoder 100 that may be a geometry-based point cloud compression (G-PCC) encoder.

In embodiments of the disclosure, in a G-PCC encoder framework, an input point cloud of a 3D image model is partitioned into slices and then each slice is encoded independently.

Refer to FIG. 3, which is a block diagram illustrating a process of G-PCC encoding provided in a relevant technical solution. In the block diagram in FIG. 3 illustrating the process of G-PCC encoding, which is applied to a point cloud encoder (i.e., an encoder), point cloud data to-be-encoded is first partitioned into multiple slices. For each slice, geometry information of the point cloud and attribute information corresponding to each point cloud are encoded separately. In the geometry encoding process, coordinate conversion is performed on the geometry information such that the whole point cloud is contained in a bounding box. This is followed by quantization, which is mainly a scaling process. Due to rounding in the quantization, some points have the same geometry information. Duplicate points are removed depending on parameters. The process of quantization and removing duplicate points is also known as voxelization. Next, octree partitioning is performed on the bounding box. Depending on the depth of the octree partitioning, encoding of the geometry information may be based on two frameworks, namely an octree-based framework and a triangle soup (trisoup)-based framework.

In the octree-based encoding process, the bounding box is octeted into 8 sub-cubes and occupancy bits of the sub-cubes are recorded. An occupancy bit of a sub-cube being 1 indicates that the sub-cube is non-empty, and in other words, the sub-cube is occupied by a point(s) in the point cloud, i.e., the sub-cube contains a point(s) in the point cloud. An occupancy bit of a sub-cube being 0 indicates that the sub-cube is empty, and in other words, the sub-cube is not occupied by any point in the point cloud, i.e., the sub-cube does not contain any point in the point cloud. Further, the non-empty sub-cubes are continued to be octeted, for example, until a resulting leaf node is a 1×1×1 unit cube.

Exemplarily, a sub-cube may be referred to as a sub-volume, which means that it is split from the bounding box or the volumetric space. In this octree, the bounding box may be referred to as a root node, and each sub-cube may be referred to as a child node of the root node.

In the octree partitioning process, spatial correlation between a node and the surrounding nodes can be used for intra prediction (intra prediction) of the occupancy bits. Then, context modelling is performed to obtain context information of the node. Finally, arithmetic encoding (such as adaptive binary arithmetic coding) is performed based on the context information, so as to generate a binary bitstream, i.e., a geometry bitstream.

In the trisoup-based encoding process, octree partitioning is also performed. Different from the octree-based encoding process, in the trisoup-based encoding process, instead of partitioning the point cloud layer-by-layer into 1×1×1 unit cubes, the partitioning is stopped when a side length of a block is W. Based on a surface formed by distribution of the point cloud in each block, up to 12 vertexes generated between the 12 edges of the block and the surface are obtained. Then, coordinates of the vertexes of each block are encoded in sequence to generate a binary bitstream, i.e. a geometry bitstream.

In the attribute encoding process, geometry encoding has been finished, and after the geometry information is reconstructed, colour conversion is performed to convert colour information (i.e., attribute information) from the RGB colour space to the YUV colour space. The reconstructed geometry information is then used to recolour the point cloud, so as to make the uncoded attribute information correspond to the reconstructed geometry information. Attribute encoding is focused on colour information. During colour information encoding, there are two main transformation methods. One is a distance-based lifting transform that relies on level of detail (LOD) partitioning. Currently, LOD partitioning is mainly classified into distance-based LOD partitioning (mainly for category 1 sequences) and LOD partitioning based on a fixed sampling rate (mainly for category 3 sequences). The other is a direct region adaptive hierarchal transform (RAHT). Both of the two methods transform the colour information from the spatial domain to the frequency domain to obtain high frequency coefficients and low frequency coefficients, and finally quantize the coefficients (i.e., quantization coefficients). Finally, slice synthesis is performed on the geometry encoding data subject to octree partitioning and surface fitting and the attribute encoding data subject to quantization coefficient processing, and then the vertex coordinates of each block are sequentially encoded (i.e., arithmetic encoding) to generate a binary attribute bitstream, i.e., an attribute bitstream.

Optionally, during encoding of the attribute information, the point cloud may be sorted according to Morton codes. Further, a geometric spatial relationship is used to search for a nearest neighbour(s) of a to-be-encoded point (also referred to as a to-be-predicted point), and a reconstructed attribute value of the found neighbour(s) is used for interpolation prediction on the to-be-encoded point to obtain a predicted attribute value. Then, a difference between the real attribute value and the predicted attribute value is calculated to obtain a prediction residual. Finally, quantization and arithmetic encoding are performed on the prediction residual, so as to obtain a binary bitstream.

Refer to FIG. 4, which is a block diagram illustrating a process of G-PCC decoding provided in a relevant technical solution. In the block diagram in FIG. 4 illustrating the process of G-PCC decoding, which is applied to a point cloud decoder (i.e., a decoder), for the obtained binary bitstream, the geometry bitstream and the attribute bitstream in the binary bitstream are first decoded independently. During decoding of the geometry bitstream, the geometry information of the point cloud is obtained through context modeling-arithmetic decoding-octree synthesis-surface fitting-geometry reconstruction-inverse coordinate conversion. During decoding of the attribute bitstream, the attribute information of the point cloud is obtained through arithmetic decoding-inverse quantization-LOD-based inverse lifting or RAHT-based inverse transformation-inverse colour transformation. The slices to-be-encoded are restored based on the geometry information and the attribute information, and finally the 3D image model of the point cloud data is obtained through slice merging.

During the context modelling involved in point cloud coding, whether a current node is eligible to be coded using a planar coding mode may be determined according to context information of the node. In the related solution, it may be determined that the current node is eligible for planar coding when the following two conditions are satisfied.

1. A local occupancy density of the node is greater than a preset threshold.

2. A proportion of nodes for which the planar coding mode in a certain direction (x-axis, y-axis, or z-axis) has been used is greater than a corresponding preset threshold. For example, three directions, i.e., the x-axis direction, the y-axis direction, and the z-axis direction, each correspond to one threshold.

For each node of the octree, two variables, namely the local occupancy density of the node of the octree structure and the proportion of nodes for which the planar coding mode in a certain direction (x-axis, y-axis, or z-axis) has been used, are updated in real time.

For example, the local occupancy density of the node may be updated according to the number of occupied nodes (numSibling) in a parent node of the node, i.e., the number of occupied nodes among 8 nodes that include the other 7 sibling nodes of the node and the node itself. The specific formula (1) may be as follows.

$$OccupancyDensity = ( 255 * OccupancyDensity + 1024 * numSiblings + 128 ) ≫ 8 \qquad ( 1 )$$

In the above, OccupancyDensity on the left side of the formula represents the updated local occupancy density of the current node. OccupancyDensity on the right side of the formula represents the local occupancy density of the current node before the update, for example, the local occupancy density of the previous node after the real-time update.

Therefore, updating of the two variables, namely the local occupancy density of each node of the octree structure and the proportion of nodes for which the planar coding mode in a certain direction (x-axis, y-axis, or z-axis) has been used, brings about great computation complexity. In addition, 4 thresholds are set for the above two conditions, which further increases computation difficulty and leads to relatively low coding gains.

An encoding method is provided in embodiments of the disclosure, in which planar-encoding-mode eligibility corresponding to a node-layer of the tree structure for the geometry information of the point cloud is determined, and whether a node (such as the current node) in the node-layer is encoded using a planar encoding mode is determined according to the planar-encoding-mode eligibility corresponding to the node-layer. In embodiments of the disclosure, by determining planar-encoding-mode eligibility corresponding to a node-layer of the tree structure corresponding to the geometry information of the point cloud, the planar-encoding-mode eligibility does not need to be determined for each node in the tree structure, thereby reducing computation complexity of encoding and also improving encoding gains.

Further, a decoding method is provided in embodiments of the disclosure, which is corresponding to the above encoding method. Specifically, whether a current node is decoded using a planar decoding mode can be determined by directly determining a planar mode enable flag. In embodiments of the disclosure, by determining whether a planar decoding mode can be used for a node-layer in a tree structure corresponding to geometry information of a point cloud, the planar-decoding-mode eligibility does not need to be determined for each node in the tree structure, thereby reducing the computation complexity of decoding and also improving decoding gains.

Embodiments of the disclosure are described in detail below with reference to the accompanying drawings.

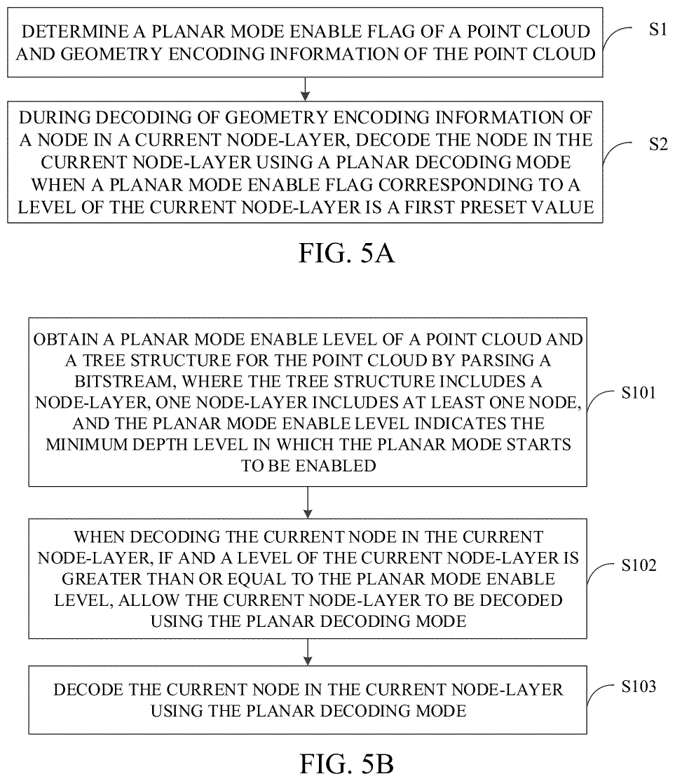

Refer to FIG. 5A, which is a schematic flowchart illustrating a decoding method provided in embodiments of the disclosure. The method is applied to a decoder (which may also be referred to as a point cloud decoder) and acts on context modeling in FIG. 4. The method includes the following.

At S1, a planar mode enable flag of a point cloud and geometry encoding information of the point cloud are determined.

At S2, during decoding of geometry encoding information of a node in a current node-layer, the node in the current node-layer is decoded using a planar decoding mode when a planar mode enable flag corresponding to a level of the current node-layer is a first preset value.

In embodiments of the disclosure, a point to-be-decoded represents a point or node in the point cloud of point cloud data of an object to-be-decoded. An encoder, when encoding, can obtain multiple slices by spatially partitioning the point cloud data. The encoding method or decoding method provided in embodiments of the disclosure is performed on the point cloud in each slice. Therefore, the decoder, when decoding, decodes the point cloud in each slice, and finally obtains all decoded information by slice merging, and thus obtains a 3D image model.

In embodiments of the disclosure, for each slice, the decoder may obtain related information of a tree structure, e.g., an octree structure, corresponding to geometry information of the point cloud, and then obtain the tree structure for the geometry information of the point cloud, e.g., the octree structure.

In some optional embodiments, the decoder may obtain the number of points in the point cloud and related information of the octree structure, such as the number of layers and node information of each layer, which are transmitted by the encoding end (such as the encoder), and such information can be transmitted to the decoder together with a binary bitstream. Exemplarily, the number of points in the point cloud and the related information of the octree structure may be included in a header file for transmission, which is not limited herein.

In embodiments of the disclosure, the tree structure for the point cloud in each slice may include at least two node-layers, and each node-layer may include at least one node.

Exemplarily, the volumetric space corresponding to the point cloud may be split to obtain the tree structure, where the volumetric space corresponds to a root node in the tree structure, and sub-volumes split from the volumetric space correspond to nodes of the tree structure. In detail, for the tree structure, reference may be made to the description in FIG. 1 and FIG. 2, which is not repeated herein.

Exemplarily, the encoder 100 obtains the octree structure for the geometry information of the point cloud by performing coordinate conversion, voxelization, and octree partitioning on the geometry information of the point cloud. The octree structure may have at least one node-layer, such as the 0-th layer, the 1st layer, . . . , and the M-th layer in sequence, where M is a positive integer greater than 1.

It may be noted that the octree structure may correspond to a tree structure obtained by octree partitioning in the octree-based encoding process, and may also correspond to a tree structure obtained by octree partitioning in the trisoup-based encoding process, which is not limited herein.

In embodiments of the disclosure, the decoder can determine the planar mode enable flag corresponding to the node-layer, so that whether the node in the current node-layer is decoded using the planar decoding mode can be directly determined according to the planar mode enable flag. The decoder obtains the geometry encoding information of the point cloud (a slice), and during decoding of the geometry encoding information of the node in the current node-layer, the decoder decodes the node in the current node-layer using the planar decoding mode when the planar mode enable flag corresponding to the level of the current node-layer is the first preset value. If the planar mode enable flag corresponding to the level of the current node-layer is a second preset value, the node in the current node-layer is not decoded using the planar decoding mode.

In some embodiments of the disclosure, the planar mode enable flag indicates whether the planar decoding mode is allowed for the node-layer. Different values may indicate that it is allowed or disallowed. When the planar mode enable flag is the first preset value, it indicates that the planar decoding mode is allowed for the current node-layer. When the planar mode enable flag is the second preset value, it indicates that the planar decoding mode is disallowed for the current node-layer.

Exemplarily, the first preset value may be 1 and the second preset value may be 0, which are not limited herein.

In some embodiments of the disclosure, the decoder may determine the planar mode enable flag of the point cloud in the following two manners.

Manner 1, the decoder obtains the planar mode enable flag corresponding to the level of the current node-layer by parsing the bitstream.

Manner 2, the decoder obtains a planar mode enable level of the point cloud by parsing the bitstream. The planar mode enable level indicates the minimum depth level in which the planar mode starts to be enabled. If the level of the current node-layer is greater than or equal to the plane mode enable level, it is determined that the plane mode enable flag corresponding to the level of the current node-layer is the first preset value.

That is, the planar mode enable flag may be generated at the same time as encoding each node-layer, and transmitted to the decoder by the encoder.

It may be noted that for a plane mode enable flag corresponding to a level of a node-layer, when encoding of a slice is finished, plane mode enable flags of all node-layers may be encoded as a slice-level flag in the form of an array and then signalled into the bitstream, or the plane mode enable flag corresponding to the level of the node-layer may be signalled into the bitstream as a layer-level flag of each node-layer, which are not limited herein.

It may be understood that since the planar mode enable flag can be obtained at the time of decoding, whether the current node-layer is decoded using the planar decoding mode can be determined according to the planar mode enable flag, which simplifies the process of calculating the planar-encoding-mode eligibility of the current node-layer at the decoder end, thereby reducing the computation complexity of decoding and also improving the decoding gains.

In addition, the minimum depth level in which the planar mode starts to be enabled (the planar mode enable level) may be encoded by the encoding end and then transmitted to the decoder, so that the decoder can determine the planar mode enable flag according to the planar mode enable level.

It may be noted that in embodiments of the disclosure, the decoder may obtain the planar mode enable level of the point cloud from the bitstream, where the planar mode enable level indicates the minimum depth level in which the planar mode starts to be enabled in the point cloud. The planar mode enable level indicates a layer number of a level in which the planar decoding mode starts to be enabled.

In some embodiments of the disclosure, when decoding the node in the current node-layer, if the level of the current node-layer is less than the planar mode enable level, it is determined that the planar mode enable flag of the point cloud is the second preset value.

In embodiments of the disclosure, planar_mode_min_octree_depth_minus1 may be used to indicate the planar mode enable level, which is not limited herein.

In some embodiments of the disclosure, after decoding the node in the current node-layer using the planar decoding mode, the decoder may also decode the node in the current node-layer using either a point location direct-decoding-mode or an occupancy bit decoding mode to complete the decoding process. For nodes for which the planar decoding mode is not used, the decoder still needs to perform decoding using either the point location direct-decoding-mode or the occupancy bit decoding mode.

It may be noted that one node is decoded using either the point location direct-decoding-mode or the occupancy bit decoding mode.

In some embodiments of the disclosure, when the planar mode enable flag corresponding to the level of the current node-layer is the first preset value, it is allowed to use the planar decoding mode in a direction of a k-th axis to decode the node, where k represents a coordinate component. When the planar mode enable flag corresponding to the level of the current node-layer is a second preset value, it is disallowed to use the planar decoding mode in the direction of the k-th axis to decode the node.

In some embodiments of the disclosure, whether the node is decoded using the planar decoding mode in the direction of the k-th axis is indicated by planar-decoding-mode eligibility of the k-th axis of the node.

In some optional embodiments, it is determined that the node is decoded using the planar decoding mode in the direction of the k-th axis, when the planar mode enable flag corresponding to the level of the current node-layer is the first preset value and the node in the current node-layer satisfies at least one of the following conditions. These conditions include: the planar decoding mode being enabled for the node, the k-th axis of an occupancy tree node corresponding to the node being decoded, or the node being a non-leaf node.

It is noted that in embodiments of the disclosure, the decoder may use the planar-decoding-mode eligibility of the k-th axis of the node to indicate whether the node is allowed to be decoded using the planar decoding mode.

In embodiments of the disclosure, PlanarEligible[k] may be used to represent the planar-decoding-mode eligibility of the k-th axis of the node. Exemplarily, PlanarEligible[k]=1 indicates that it is determined that the node is decoded using the planar decoding mode in the direction of the k-th axis, i.e., allowed, and PlanarEligible[k]=0 indicates that it is determined that the node is not decoded using the planar decoding mode in the direction of the k-th axis, i.e., disallowed.

If the level of the current node-layer is greater than or equal to the planar mode enable level, it is determined that the planar mode enable flag corresponding to the level of the current node-layer is the first preset value, so that PlanarEligible[k] is determined to be 1.

It may be noted that, during encoding, the planar mode enable flag may be directly assigned a value by using the planar coding eligibility of the node-layer, or may be generated independently, which is not limited herein. PlanarEligible[k] may be directly assigned a value based on the planar coding eligibility of the node-layer planarEligibleKOctreeDepth or may be determined based on the planar mode enable flag, which is not limited herein. The planar coding eligibility may be represented by planarEligibleKOctreeDepth. The planar coding eligibility of the node-layer is determined at the time of encoding and will be described in later embodiments.

It may be noted that k being 0, 1, and 2 may represent different coordinate components x, y, and z.

Exemplarily, PlanarEligible[k]=1 may indicate that the node is decoded using the planar decoding mode in the direction of the k-th axis. Exemplarily, a value of PlanarEligible[k] may be determined according to “the planar decoding mode is enabled & the k-th axis of the occupancy tree node is decoded & the node is a non-leaf node”, and whether the j-th node is decoded using the planar decoding mode in the direction of the k-th axis can be determined according to the value of PlanarEligible[k]. When PlanarEligible[k]=1, the j-th node is decoded using the planar decoding mode in the direction of the k-th axis.

It may be understood that the decoder can directly obtain the planar mode enable level by parsing the bitstream, and thus directly determine whether to decode the current node-layer using the planar decoding mode. Therefore, the computation on whether the current node-layer proceeds to the planar decoding mode at the decoder side can be reduced, and the computation complexity can be reduced.

It may be noted that in the decoding method provided in embodiments of the disclosure, the decoder may also directly determine, by parsing only the planar mode enable level, whether to proceed to the planar decoding mode. As illustrated in FIG. 5B, an example that a node to-be-decoded is a current node in a current node-layer is taken for description.

At S101, a planar mode enable level of a point cloud and a tree structure for the point cloud are obtained by parsing a bitstream. The tree structure includes a node-layer, and one node-layer includes at least one node. The planar mode enable level indicates the minimum depth level in which the planar mode starts to be enabled.

At S102, when decoding the current node in the current node-layer, if a level of the current node-layer is greater than or equal to the planar mode enable level, the current node-layer is allowed to be decoded using the planar decoding mode.

At S103, the current node in the current node-layer is decoded using the planar decoding mode.

In the decoding process, the decoder decodes each node in each node-layer in turn. When decoding the current node in the current node-layer, the decoder compares the level of the current node-layer and the planar mode enable level. When the level of the current node-layer is greater than or equal to the planar mode enable level, since the planar mode enable level is a level in which the planar decoding mode starts to be enabled, all levels after a level of a node-layer indicated by the planar mode enable level can proceed to the planar decoding mode. Therefore, the level of the current node-layer being greater than or equal to the planar mode enable level indicates that the current node-layer can be decoded using the planar decoding mode, so that the current node is allowed to be decoded using the planar decoding mode. In this way, the decoder can decode the current node in the current node-layer using the planar decoding mode.

In some embodiments of the disclosure, if the level of the current node-layer is greater than or equal to the planar mode enable level, the current node in the current node-layer is allowed to be decoded using the planar decoding mode in the direction of the k-th axis. k represents a coordinate component. The decoder decodes the current node in the current node-layer using the planar decoding mode in the direction of the k-th axis.

In some optional embodiments, it is determined that the current node is decoded using the planar decoding mode in the direction of the k-th axis, if the level of the current node-layer is greater than or equal to the planar mode enable level and the current node satisfies at least one of the following conditions. These conditions include: the planar decoding mode being enabled for the current node, the k-th axis of an occupancy tree node corresponding to the current node being decoded, or the current node being a non-leaf node.

That is, before the decoder allows the current node to be decoded using the planar decoding mode, the decoder further needs to determine that the current node satisfies at least one of: the planar decoding mode for being enabled the current node, the k-th axis of an occupancy tree node corresponding to the current node being decoded, or the current node being a non-leaf node in a tree structure.

It may be understood that the decoder can directly obtain the planar mode enable level by parsing the bitstream, and thus directly determine whether to decode the current node-layer using the planar decoding mode. Therefore, the computation on whether the current node-layer proceeds to the planar decoding mode at the decoder side can be reduced, and the computation complexity can be reduced.

In some embodiments of the disclosure, the decoding method provided in embodiments of the disclosure may further include the following.

At S104, during decoding of the current node in the current node-layer, when the level of the current node-layer is less than the planar mode enable level, the current node is disallowed to be decoded using the planar decoding mode.

In embodiments of the disclosure, when the level of the current node-layer is less than the planar mode enable level, the current node is disallowed to be decoded using the planar decoding mode in the direction of the k-th axis.

Since the planar mode enable level is a level in which the planar decoding mode starts to be enabled, all levels after a level of a node-layer indicated by the planar mode enable level can proceed to the planar decoding mode. Therefore, when the level of the current node-layer is less than the planar mode enable level, i.e., the level of the current node-layer is a level prior to the planar mode enable level, the current node is disallowed to be decoded using the planar decoding mode. Therefore, the level of the current node-layer being less than the planar mode enable level indicates that the current node is disallowed to be decoded using the planar decoding mode.

In embodiments of the disclosure, if the level of the current node-layer is less than the planar mode enable level, the current node is disallowed to be decoded using the planar decoding mode in the direction of the k-th axis.

Exemplarily, PlanarEligible[k] is determined as 0 if the level of the current node-layer is less than the planar mode enable level.

In some embodiments of the disclosure, during decoding of the current node, when the level of the current node-layer is less than the planar mode enable level, whether the current node-layer is allowed to be decoded using the planar decoding mode can be determined using the method at S105 to S108 as follows.

At S105, in a node-layer(s) prior to the current node-layer in the point cloud, the number of points for which a point location direct-decoding-mode is used is determined.

At S106, the first number of occupied child nodes corresponding to a previous node-layer of the current node-layer is determined, where the first number of occupied child nodes is a total number of occupied child nodes of a node(s) that is decoded using an occupancy bit decoding mode in the previous node-layer.

At S107, a point cloud density of the current node-layer is determined according to the number of points in the point cloud, the number of points for which the point location direct-decoding-mode is used, and the first number of occupied child nodes.

At S108, whether the current node-layer is allowed to be decoded using the planar decoding mode is determined according to the point cloud density of the current node-layer.

In embodiments of the disclosure, the decoder determines the point cloud density of the current node-layer, and determines planar-decoding-mode eligibility of the current node-layer according to the point cloud density of the current node-layer. Exemplarily, for the (i=1, 2, 3 . . . )-th node-layer of an octree structure, planar coding eligibility (corresponding to planar coding eligibility during encoding, i.e., planarEligibleKOctreeDepth) for the node-layer may be determined according to the point cloud density of the node-layer.

In some embodiments of the disclosure, as a possible implementation of determining the point cloud density of the current node-layer, the number of points for which the point location direct-decoding-mode is used (numPointsCodedByIdcm) may be determined in the node-layer(s) prior to the current node-layer in the point cloud, and the current number of occupied child nodes corresponding to the previous node-layer of the current node-layer (numSubnodes) may be determined. The current number of occupied child nodes is the total number of occupied child nodes of a node(s) that is decoded using the occupancy bit decoding mode in the previous node-layer. The point cloud density of the current node-layer (which may be represented by realDensity) is determined according to the number of points in the point cloud (numPoints), the number of points for which the point location direct-decoding-mode is used, and the current number of occupied child nodes.

The node-layer(s) prior to the current node-layer may include all node-layers prior to the current node-layer. For example, when the current node-layer is the 3rd node-layer, the node-layers prior to the current node-layer include the 0-th layer, the 1st layer, and the 2nd layer. In this case, the previous node-layer of the current node-layer is the 2nd node-layer.

Exemplarily, the decoder determines the point cloud density of the current node-layer (which may be represented by realDensity) according to the number of points in the point cloud (numPoints), the number of points for which the point location direct-decoding-mode is used, and the current number of occupied child nodes, as illustrated in formula (2):

$$realDensity = ( numPoints - numPointsCodedByIdcm ) / numSubnodes \qquad ( 2 )$$

It may be noted that, assuming the current node-layer is the i-th layer, when determining the realDensity of the i-th layer, the current number of occupied child nodes is the total number of occupied child nodes of a node(s) that is decoded using the occupancy bit decoding mode in the (i−1)-th node-layer, which may be, for example, numSubnodes when proceeding to the (i−1)-th layer of the octree.

In some optional embodiments, when the node in the current node-layer is decoded using the point location direct-decoding-mode, a value of the number of points for which the point location direct-decoding-mode is used is updated. Exemplarily, the nodes for which the point location direct-decoding-mode is used includes a decoded node that proceeds to the planar decoding mode in the current node-layer, as well as a decoded node that does not proceed to using the planar decoding mode in the current node-layer, which is not limited herein.

Exemplarily, the number of points for which the point location direct-decoding-mode is used may be represented as numPointsCodedByIdcm.

It is noted that before decoding the node in the current node-layer in the tree structure, the number of points for which the point location direct-decoding-mode is used is initialized, exemplarily, numPointsCodedByIdcm may be initialized as 0.

In some optional embodiments, when the node in the current node-layer is decoded using the occupancy bit decoding mode, the second number of occupied child nodes corresponding to the current node-layer is updated. The second number of occupied child nodes is the number of occupied child nodes of the node that is decoded using the occupancy bit decoding mode in the current node-layer. Exemplarily, the nodes for which the occupancy bit decoding mode is used includes a decoded node that proceeds to the planar decoding mode in the current node-layer, as well as a decoded node that does not proceed to the planar decoding mode in the current node-layer, which is not limited herein.

It is noted that the second number of occupied child nodes is the total number of occupied child nodes of a node(s) that is decoded using the occupancy bit decoding mode in the i-th node-layer, which may be, for example, numSubnodes when proceeding to the (i+1)-th layer of the octree. The second number of occupied child nodes may be used to determine the realDensity of the (i+1)-th layer.

In some optional embodiments, before decoding nodes in the 1st node-layer, the second number of occupied child nodes is initialized. Exemplarily, numSubnodes in the i-th layer may be initialized as 0.

In embodiments of the disclosure, if the point cloud density is less than a preset threshold, it is determined that the current node is allowed to be decoded using the planar decoding mode. If the point cloud density is greater than or equal to the preset threshold, it is determined that the current node is disallowed to be decoded using the planar decoding mode.

In some optional embodiments, a possible implementation of determining planar-decoding-mode eligibility of the current node-layer according to the point cloud density of the current node-layer is illustrated in formula (3). If the point cloud density is less than the preset threshold, it is determined that the planar-decoding-mode eligibility indicates that the current node is decoded using the planar decoding mode. In this case, the value of planarEligibleKOctreeDepth can be set to 1, i.e., planarEligibleKOctreeDepth=1, i.e., the current node can be decoded using the planar decoding mode. If the point cloud density is greater than or equal to the prediction threshold, it is determined that the planar-decoding-mode eligibility indicates that the current node is not decoded using the planar decoding mode. In this case, the value of planarEligibleKOctreeDepth can be set to 0, i.e., planarEligibleKOctreeDepth=0, i.e., the current node cannot be decoded using the planar decoding mode.

In some optional embodiments, the preset threshold is greater than or equal to 1. For example, the preset threshold is set to 1.3.

Formula (3) is illustrated as follows:

$$planarEligibleKOctreeDepth = \{ \begin{matrix}1 , & realDensity < 1.3 \\ 0 , & otherwise\end{matrix} \qquad ( 3 )$$

In some embodiments of the disclosure, after the operation at S103 or S104, the above method further includes an operation at S109 or S1010 as follows.

At S109, the current node is decoded using the point location direct-decoding-mode.

At S1010, the current node is decoded using the occupancy bit decoding mode.

In embodiments of the disclosure, the decoder decodes the current node using the point location direct-decoding-mode, or the decoder decodes the current node using the occupancy bit decoding mode. Then the decoder continues to decode the next node (i.e., starts to decode the next node using the planar decoding mode, followed by decoding using either the point location direct-decoding-mode or the occupancy bit decoding mode) until decoding of the current node-layer is finished. The decoder then continues to decode the next node-layer until decoding of all node-layers is finished.

In some embodiments of the disclosure, the decoder may first compare the level of the current node-layer with the planar mode enable level. When the level of the current node-layer is greater than or equal to the planar mode enable level, the decoder determines, according to the planar mode enable flag of the current node-layer, whether to decode the current node-layer using the planar decoding mode. The comparison between the level of the current node-layer and the planar mode enable level and the use of the planar mode enable flag of the current node-layer, may be arbitrarily combined to jointly determine whether to decode the current node-layer using the planar decoding mode, which is not limited herein.

Exemplarily, the decoding process is illustrated as follows.

1. Decode to obtain a parameter planar_mode_max_octree_depth_minus1 (the minimum octree depth level in which the planar mode starts to be enabled) in the current point cloud slice.

2. Proceed to the i-th layer of the octree (the minimum value of i is 0).

3. Read the j-th node (the minimum value of j is 0). When the node satisfies the three conditions that the plane decoding mode is enabled, the k-th axis (k takes a value from 0, 1, and 2) of the occupancy tree node is coded, and the node is a non-leaf node, and if i≥planar_mode_max_octree_depth_minus1, PlanarEligible[k] (planar-decoding-mode eligibility of the direction of the k-th axis of the current node) is set to 1; otherwise, PlanarEligible[k] is set to 0. If the planar-decoding-mode eligibility of the direction of the k-th axis=1, proceed to the planar decoding mode.

4. After the j-th node passes through the planar decoding mode, if the node is eligible for the point location direct-decoding-mode, location information of a point(s) in the node is directly decoded. Otherwise, the node is decoded using the occupancy bit decoding mode, and occupancy information of 8 child nodes of the node is binary decoded.

5. Proceed to step 3 to read the next node. When decoding of all nodes in the i-th layer of the octree is finished, proceed to step 2 to the next layer of the octree. If decoding of all nodes in all layers is finished, the process ends.

It may be understood that the decoder can determine whether the node-layer can proceed to the planar decoding mode by determining whether the level of the node-layer in the tree structure for the point cloud is greater than the planar mode enable level, so that the process of determining planar-decoding-mode eligibility for each node in the tree structure can be omitted, thereby reducing the computation complexity of decoding and also improving decoding gains.

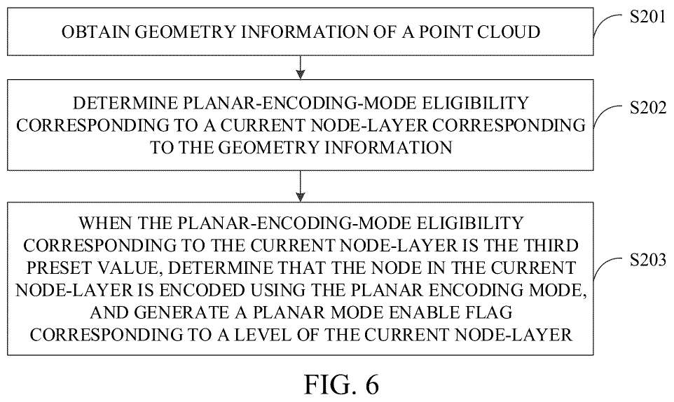

Refer to FIG. 6, which is a schematic flowchart illustrating an encoding method provided in embodiments of the disclosure. The method is applied to an encoder (which may also be referred to as a point cloud encoder) and acts on context modeling in FIG. 3. The method may include the following.

At S201, geometry information of a point cloud is obtained.

In embodiments of the disclosure, the encoder, when encoding, can obtain multiple slices by spatially partitioning point cloud data. The encoding method provided in embodiments of the disclosure is performed on the point cloud in each slice.

In embodiments of the disclosure, for each slice, the decoder may obtain related information of a tree structure, e.g., an octree structure, for the point cloud, and then obtain a tree structure for the geometry information of the point cloud, e.g., the octree structure.

In embodiments of the disclosure, the tree structure for the point cloud in each slice may include at least two node-layers, and each node-layer may include at least one node.

Exemplarily, the volumetric space corresponding to the point cloud may be split to obtain the tree structure, where the volumetric space corresponds to a root node in the tree structure, and sub-volumes split from the volumetric space correspond to nodes of the tree structure. In detail, for the tree structure, reference may be made to the description in FIG. 1 and FIG. 2, which is not repeated herein.

Exemplarily, the encoder 100 obtains the octree structure for the geometry information of the point cloud by performing coordinate conversion, voxelization, and octree partitioning on the geometry information of the point cloud. The octree structure may have at least one node-layer, such as the 0-th layer, the 1st layer, . . . , and the M-th layer in sequence, where M is a positive integer greater than 1.

It may be noted that the octree structure may correspond to a tree structure obtained by octree partitioning in the octree-based encoding process, and may correspond to a tree structure obtained by octree partitioning in the trisoup-based encoding process, which is not limited herein.

At S202, planar-encoding-mode eligibility corresponding to a current node-layer corresponding to the geometry information is determined.

In embodiments of the disclosure, the encoder may determine, for each node-layer, the planar-encoding-mode eligibility corresponding to the node-layer.

For the process of encoding the nodes in the current node-layer, the following describes the process of encoding the current node. That is, the description is focus on the current node, where the current node refers to a node that is being encoded in the current node-layer.

In some embodiments of the disclosure, the planar-encoding-mode eligibility corresponding to the current node-layer corresponding to the geometry information may be determined in the following two manners.

Manner 1: the encoder determines the point cloud density of the current node-layer, and determines the planar-encoding-mode eligibility corresponding to the current node-layer according to the point cloud density of the current node-layer.

In some embodiments of the disclosure, the encoder determines, in a node-layer(s) prior to the current node-layer in the point cloud, the number of points for which a point location direct-encoding-mode is used. The encoder determines the first number of occupied child nodes corresponding to a previous node-layer of the current node-layer, where the first number of occupied child nodes is the total number of occupied child nodes of a node(s) that is encoded using an occupancy bit encoding mode in the previous node-layer. The encoder determines the point cloud density of the current node-layer according to the number of points in the point cloud, the number of points for which the point location direct-encoding-mode is used, and the first number of occupied child nodes.

In some embodiments of the disclosure, the encoder may determine the point cloud density of the current node-layer according to the number of points in the point cloud, the number of points for which the point location direct-encoding-mode is used, and the first number of occupied child nodes as follows. When the point cloud density is less than a preset threshold, the encoder determines that the planar-encoding-mode eligibility corresponding to the current node-layer is a third preset value. When the point cloud density is greater than or equal to the preset threshold, the encoder determines that the planar-encoding-mode eligibility corresponding to the current node-layer is a fourth preset value.

In embodiments of the disclosure, the preset threshold is greater than or equal to 1. The third preset value indicates that the process can proceed to the planar encoding mode, e.g., the third preset value is 1. The fourth preset value indicates that the process cannot proceed to the planar encoding mode, e.g., the fourth preset value is 0.

It may be noted that the description and principle of the process that the encoder determines the planar-encoding-mode eligibility corresponding to the current node-layer in manner 1 is consistent with the description and principle of the operations at S105 to S108 performed by the decoder, which is not repeated herein.

It may be noted that the planar-encoding-mode eligibility corresponding to the current node-layer is determined in manner 1 only when the planar-encoding-mode eligibility corresponding to the current node-layer is the fourth preset value.

It may be understood that the encoder determines the planar-encoding-mode eligibility corresponding to the node-layer in the tree structure corresponding to the geometry information of the point cloud in manner 1, so that a process of determining planar-encoding-mode eligibility for each node in the tree structure can be omitted, thereby reducing computation complexity of encoding and also improving encoding gains.

Manner 2: when planar-encoding-mode eligibility corresponding to a previous node-layer of the current node-layer in the tree structure is the third preset value, the encoder determines that the planar-encoding-mode eligibility corresponding to the current node-layer is the third preset value.

In the process of encoding the non-first node-layer in each slice, the encoder may first determine planar-encoding-mode eligibility corresponding to the previous node-layer. If the planar-encoding-mode eligibility corresponding to the previous node-layer of the current node-layer in the tree structure is the third preset value, the encoder may directly determine that the planar-encoding-mode eligibility corresponding to the current node-layer is the third preset value, without having to calculate the point cloud density of the current node-layer.

That is, in the encoding process, once calculated planar-encoding-mode eligibility corresponding to one node-layer is the third preset value, i.e., the node-layer starts to proceed to the planar encoding mode, the encoder determines that all other node-layers to be encoded later are eligible for the planar encoding mode. That is, the encoder determines that the planar-encoding-mode eligibility corresponding to the current node-layer is the third preset value.

It may be understood that, compared to manner 1, the use of manner 2 by the encoder further reduces the number of times and calculations that the encoder determines planar-encoding-mode eligibility of each node-layer, and reduces the computation complexity of the encoding.

At S203, when the planar-encoding-mode eligibility corresponding to the current node-layer is the third preset value, it is determined that the node in the current node-layer is encoded using the planar encoding mode, and a planar mode enable flag corresponding to a level of the current node-layer is generated.

In embodiments of the disclosure, when the planar-encoding-mode eligibility corresponding to the current node-layer is the third preset value, the encoder directly encodes the current node (i.e., the node) in the current node-layer using the planar encoding mode.

In some embodiments of the disclosure, it is determined that the current node is encoded using the planar encoding mode in a direction of a k-th axis, when the planar-encoding-mode eligibility corresponding to the current node-layer is the third preset value and the current node satisfies at least one of the following conditions, where k represents a coordinate component. These conditions include: the planar encoding mode being enabled for the current node, the k-th axis of an occupancy tree node corresponding to the current node being encoded, or the current node being a non-leaf node.

It may be noted that the principle by which the encoder determines that the current node is encoded using the planar encoding mode in the direction of the k-th axis is consistent with the principle by which the decoder determines that the current node is decoded using the planar decoding mode in the direction of the k-th axis, which is not repeated herein.

In some embodiments of the disclosure, if the planar-encoding-mode eligibility corresponding to the current node-layer is the fourth preset value, it is determined that the node in the current node-layer is not encoded using the planar encoding mode, and the planar mode enable flag corresponding to the level of the current node-layer is generated as a second preset value.

It may be noted that if the planar-encoding-mode eligibility corresponding to the current node-layer is the third preset value, the planar mode enable flag corresponding to the level of the current node-layer is generated as a first preset value.

Exemplarily, the first preset value may be 1, and the second preset value may be 0, which is not limited herein.

It may be understood that when the encoder determines the planar-encoding-mode eligibility of each node-layer in manner 1, the encoder may further generate a planar mode enable flag of each node-layer according to the planar-encoding-mode eligibility and transmit the planar mode enable flag to the decoder for use by the decoder in decoding.

In some embodiments of the disclosure, if the planar-encoding-mode eligibility corresponding to the current node-layer is the third preset value, it is determined that the node(s) in the current node-layer is encoded using the planar encoding mode, and the level of the current node-layer is signalled into the bitstream as a planar mode enable level, so that the decoder can decode the current node-layer using the planar decoding mode when parsing the planar mode enable level.

It may be noted that the encoder may encode and signal the planar mode enable level into the bitstream when encoding of all node-layers are finished.

In some embodiments of the disclosure, when the planar-encoding-mode eligibility corresponding to the current node-layer is the third preset value and the planar-encoding-mode eligibility corresponding to the previous node-layer of the current node-layer is the fourth preset value, the level of the current node-layer is signalled into the bitstream as the planar mode enable level.

It is noted that the encoder may signal all levels of node-layers whose planar-encoding-mode eligibilities are the third preset value into the bitstream, for use by the decoder when the decoder decodes each corresponding node layer. Optionally, the encoder may record, when proceeding to the planar encoding mode at the first time, the minimum depth level in which the planar mode starts to be enabled, and signal the minimum depth level in which the planar mode starts to be enabled into the bitstream as the planar mode enable level. The disclosure is not limited thereto.

It may be understood that when the encoder has determined the minimum depth level in which the planar mode starts to be enabled, the encoder may transmit only the minimum depth level in which the planar mode starts to be enabled as the planar mode enable level for use by the decoder in decoding, thereby reducing the amount of transmission.

In some embodiments of the disclosure, the encoder may generate the planar mode enable flag corresponding to the level of the current node-layer as follows. When the level of the current node-layer is taken as the planar mode enable level, the encoder generates the planar mode enable flag corresponding to the level of the current node-layer as a first preset value. Otherwise, the encoder generates the planar mode enable flag as a second preset value.

In some embodiments of the disclosure, when the encoder determines the planar-encoding-mode eligibility corresponding to the current node-layer according to the point cloud density, if the planar-encoding-mode eligibility corresponding to the current node-layer is the third preset value and the planar-encoding-mode eligibility corresponding to the previous node-layer is the fourth preset value, the encoder signals the level of the previous node-layer into the bitstream as the planar mode enable level. In an implementation, at the decoder end, if the level of the current node-layer is greater than the planar mode enable level, it is allowed to decode the current node using the planar decoding mode. Otherwise, it is not allowed to decode the current node using the planar decoding mode.

In some embodiments of the disclosure, after the operation at S203, or when the planar-encoding-mode eligibility corresponding to the current node-layer is the fourth preset value, the method further includes an operation at S204.

At S204, the node in the current node-layer is encoded using either a point location direct-encoding-mode or an occupancy bit encoding mode.

In embodiments of the disclosure, the encoder encodes the node in the current node-layer using either the point location direct-encoding-mode or the occupancy bit encoding mode. Then the encoder continues to encode the next node (using the planar encoding mode, the point location direct-encoding-mode, or the occupancy bit encoding mode) until encoding of the current node-layer is finished. The encoder then encodes the next node-layer until encoding of all node-layers is finished.

In some embodiments of the disclosure, when the planar-encoding-mode eligibility corresponding to the current node-layer is the fourth preset value and the current node in the current node-layer is encoded using the point location direct-encoding-mode, the encoder updates a value of the number of points for which the point location direct-encoding-mode is used. When the planar-encoding-mode eligibility corresponding to the current node-layer is the fourth preset value and the current node in the current node-layer is encoded using the occupancy bit encoding mode, the encoder updates the second number of occupied child nodes corresponding to the current node-layer. The second number of occupied child nodes is the number of occupied child nodes of the node that is encoded using the occupancy bit encoding mode in the current node-layer.

It may be understood that only when the planar-encoding-mode eligibility corresponding to the current node-layer is the fourth preset value, the encoder updates the number of points for which the point location direct-encoding-mode is used or the second number of occupied child nodes, for determination of planar-encoding-mode eligibility of the next node-layer. However, when the planar-encoding-mode eligibility corresponding to the current node-layer is the third preset value, instead of updating the number of points for which the point location direct-encoding-mode is used or the second number of occupied child nodes, the encoder may determine the planar-encoding-mode eligibility corresponding to the current node-layer as the planar-encoding-mode eligibility of the next node-layer, i.e., the third preset value. In this way, the computation complexity of the encoding process can be reduced.

Exemplarily, a method for determining a planar encoding mode is provided in embodiments of the disclosure, in which a uniform planar-encoding-mode eligibility is set for all nodes in a certain layer under an octree framework. An example is taken for illustrating the process of encoding a planar mode enable level. The encoding process is illustrated as follows.

1. Obtain the number of points in the current point cloud slice numPoints, assign planarEligibleKOctreeDepth=0 (planar-encoding-mode eligibility of a certain layer in an octree), and assign numPointsCodedByIdcm=0 (the number of points for which the point location direct-encoding-mode is used).

2. Proceed to the i-th layer of the octree (the minimum value of i is 0), and assign numSubnodes=0 (the number of occupied child nodes generated from all nodes in the i-th layer).

3. Read the j-th node (the minimum value of j is 0). When the node satisfies the three conditions that the plane encoding mode is enabled, the k-th axis (k takes a value from 0, 1, and 2) of the occupancy tree node is encoded, and the node is a non-leaf node, if planarEligibleKOctreeDepth=1, PlanarEligible[k] (planar-encoding-mode eligibility of the direction of the k-th axis of the current node) is set to 1; otherwise, PlanarEligible[k] is set to 0. If the planar-encoding-mode eligibility of the direction of the k-th axis=1, proceed to the planar encoding mode.

4. After the j-th node passes through the planar encoding mode, if the j-th node is eligible for the point location direct-encoding-mode, location information of a point(s) in the node is directly encoded. When planarEligibleKOctreeDepth equals to 0, accumulation update is performed on the value of numPointsCodedByIdcm according to the number of points in the node. Otherwise, the node is encoded using the occupancy bit encoding mode, and occupancy information of 8 child nodes of the node is encoded. When planarEligibleKOctreeDepth equals to 0, accumulation update is performed on the value of numSubnodes according to the number of occupied child nodes of the node.

5. Proceed to step 3 to read the next node. When encoding of all nodes in the i-th layer of the octree is finished, if planarEligibleKOctreeDepth already equals to 1, directly proceed to step 6. Otherwise, the real density of the point cloud in the (i+1)-th layer is calculated according to formula (2). If the real density of the point cloud is less than 1.3, determine planar-encoding-mode eligibility of the (i+1)-th layer as 1 according to formula (3), otherwise, the planar-encoding-mode eligibility is 0.

If planarEligibleKOctreeDepth equals to 1, record that the parameter planar_mode_min_octree_depth_minus1 (the minimum octree depth level in which the planar mode starts to be enabled) is equal to i+1 (planarEligibleKOctreeDepth=0 at the i-th layer), and encode the parameter and transmit the encoded parameter to the decoding end.

6. Proceed to step 2 to the next layer in the octree, and the process ends if all nodes in all layers have been encoded.

It may be understood that by determining the planar-encoding-mode eligibility corresponding to the node-layer in the tree structure corresponding to the geometry information of the point cloud, the encoder does not need to determine the planar-encoding-mode eligibility for each node in the tree structure. Furthermore, once calculated planar-encoding-mode eligibility corresponding to a node-layer is the third preset value, the node-layer starts to proceed to the planar encoding mode, all other node-layers to be encoded later are eligible for the planar encoding mode, thereby reducing the number of times and calculations that the encoder determines planar-encoding-mode eligibility of each node-layer, and reducing the computation complexity of the encoding.

A coding solution provided in embodiments of the disclosure will be described in detail below in conjunction with the accompanying drawings.

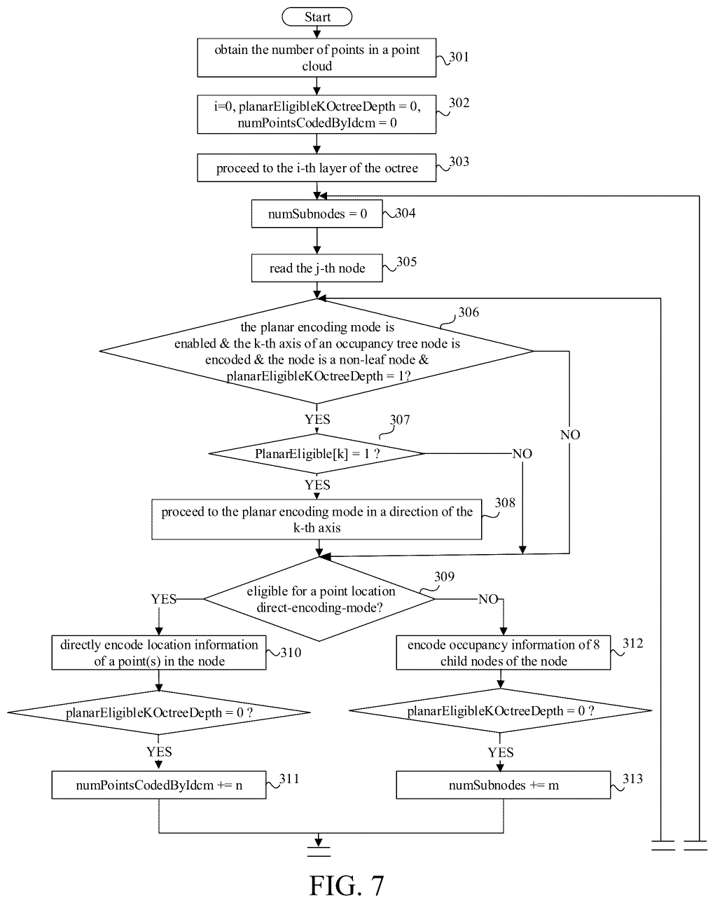

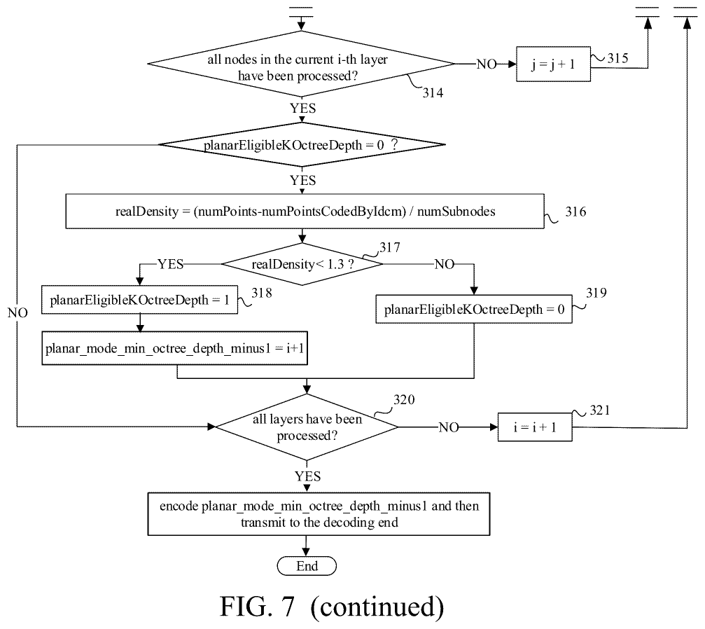

FIG. 7 is a schematic flowchart of an encoding method provided in embodiments of the disclosure. The encoding method is applicable to the encoder 100 illustrated in FIG. 3. For example, geometry information and attribute information of a point cloud may be input into the encoder 100, and thus compression encoding of the point cloud can be realized. As illustrated in FIG. 7, a process that the encoder encodes a planar mode enable level is taken as an example for description, and the method includes operations at S301 to S321.

It may be understood that, FIG. 7 illustrates steps or operations of the encoding method, but these steps or operations are merely exemplary. Other operations or various modifications of respective operations in FIG. 7 can be implemented in embodiments of the disclosure. In addition, each step in FIG. 7 may be executed in an order different from that illustrated in FIG. 7, and not all the operations illustrated in FIG. 7 may be executed.

At S301, obtain the number of points in a point cloud.

In some embodiments, during obtaining of the point cloud (a slice) or before compression encoding of the point cloud, the number of points in the point cloud, i.e., the number of all points contained in the point cloud, may be obtained. Exemplarily, the number of points in the point cloud may be represented by numPoints.

In embodiments of the disclosure, a tree structure for geometry information of the point cloud, such as an octree structure, may be obtained. The tree structure may have at least two node-layers, and each node-layer may include at least one node.

Exemplarily, a volumetric space corresponding to the point cloud is split to obtain the tree structure, where the volumetric space corresponds to a root node in the tree structure, and sub-volumes split from the volumetric space correspond to nodes of the tree structure. For the tree structure, reference can be made to the description in FIG. 1 and FIG. 2, which will not be repeated herein.

At S302, i=0, planarEligibleKOctreeDepth=0, numPointsCodedByIdcm=0.

In the above, i represents a layer number of a current encoding node-layer (the current node-layer, which is also referred to as a to-be-encoded node-layer) of the octree structure, planarEligibleKOctreeDepth represents planar-encoding-mode eligibility of the current encoding node-layer of the octree structure, and numPointsCodedByIdem represents the number of points that are encoded using a point location direct-encoding-mode in the point cloud. Exemplarily, a storage apparatus (such as a memory) of an encoding system such as the encoder 100 may store values of planarEligibleKOctreeDepth and numPointsCodedByIdcm, and update and maintain the values of planarEligibleKOctreeDepth and numPointsCodedByIdem according to the encoding of each layer.

That is to say, for i=0, i.e., when the (i=0)-th layer of the octree structure is to be encoded, planarEligibleKOctreeDepth may be initialized as 0, and numPointsCodedByIdcm may be initialized as 0. Here, planarEligibleKOctreeDepth being initialized as 0 indicates that the planar-encoding-mode eligibility corresponding to the (i=0)-th node-layer is 0, that is, nodes (such as all nodes) in the (i=0)-th node-layer are not encoded using the planar encoding mode.

At S303, proceed to the i-th layer of the octree, where 0≤i≤M, and i is an integer.

In some optional embodiments, after operations at S302 are executed, operations at S303 may be executed. In this case, i=0, i.e., proceed to encoding of the 0-th layer of the octree.

In some optional embodiments, after operations at S321 are executed, the operations at S303 may be executed. In this case, 0<i≤M, i.e., after encoding of one node-layer, proceed to encoding of a next node-layer of the node-layer.

At S304, numSubnodes=0.

Here, numSubnodes represents the number of child nodes generated from nodes (such as all nodes) in the i-th layer. It may be noted that, upon proceeding to the i-th layer of the octree, initialize numSubnodes=0.

At S305, read the j-th node, where 0≤j≤X, i is an integer, X represents the number of nodes in the i-th layer, and X is a positive integer.

At S306, whether the following are satisfied: the planar encoding mode is enabled & the k-th axis of an occupancy tree node is encoded & the node is a non-leaf node & planarEligibleKOctreeDepth=1?

That is, it is determined whether the j-th node satisfies the four conditions that the planar encoding mode is enabled, the k-th axis of the occupancy tree node is encoded, and the node is a non-leaf node, and whether planarEligibleKOctreeDept is 1.

Exemplarily, in a 3D coordinate system, k=0, 1, or 2. For example, when k=0, the k-th axis is the x-axis. When k=1, the k-th axis is the y-axis. When k=2, the k-th axis is the z-axis.

When it is determined that the j-th node satisfies the three conditions that the planar encoding mode is enabled, the k-th axis of the occupancy tree node is encoded, and the node is a non-leaf node and planarEligibleKOctreeDept=1, operations at S307 are executed next. When it is determined that the j-th node does not satisfy at least one of the conditions that the planar encoding mode is enabled, the k-th axis of the occupancy tree node is encoded, and the node is a non-leaf node, or planarEligibleKOctreeDept=0, operations at S309 are executed next.

It may be noted that, at S306, whether the j-th node satisfies the three conditions that the planar encoding mode is enabled, the k-th axis of the occupancy tree node is encoded, and the node is a non-leaf node is taken as an example for illustration, but embodiments of the disclosure are not limited thereto. For example, in some embodiments, it may also be determined whether the j-th node satisfies at least one of the three conditions or other conditions, which is not limited in the disclosure.

At S307, determine whether PlanarEligible[k] is equal to 1.

In embodiments of the disclosure, it may be further determined whether planarEligibleKOctreeDepth is 1. When planarEligibleKOctreeDepth=1, PlanarEligible[k]=1, and when planarEligibleKOctreeDepth=0, PlanarEligible[k]=0. In the above, PlanarEligible[k] represents planar-encoding-mode eligibility of the current node (i.e., the j-th node) in a direction of the k-th axis. Exemplarily, the planar-encoding-mode eligibility of the node may indicate whether the node can be encoded using the planar encoding mode. For example, when the planar-encoding-mode eligibility is 1, the node can be encoded using the planar encoding mode. When the planar-encoding-mode eligibility is 0, the node cannot be encoded using the planar encoding mode.

In some optional embodiments, a current value of planarEligibleKOctreeDepth may be obtained by reading from the memory of the encoding system such as the encoder 100, which is not limited in the disclosure.

In some optional embodiments, during encoding of the (i=0)-th node-layer, since planarEligibleKOctreeDepth has been initialized as 0, it can be determined that PlanarEligible[k]=0.

When PlanarEligible[k]=1, operations at S308 are executed next. When PlanarEligible[k]=0, operations at S309 are executed next.

At S308, proceed to the planar encoding mode in a direction of the k-th axis.

Specifically, in this case, the j-th node may be encoded using the planar encoding mode in the direction of the k-th axis.

At S309, eligible for a point location direct-encoding-mode?

In some optional embodiments, in a case where operations at S309 are executed after the operations at S308, the j-th node satisfies the three conditions that the planar encoding mode is enabled & the k-th axis of the occupancy tree node is encoded & the node is a non-leaf node, and planarEligibleKOctreeDepth corresponding to the i-th node-layer is 1. In this case, after the j-th node is encoded using the planar encoding mode, whether the j-th node is eligible for the point location direct-encoding-mode can be determined.

In some optional embodiments, in a case where the operations at S309 are executed after operations at S306 or S307, the j-th node does not satisfy at least one of the conditions that the planar encoding mode is enabled & the k-th axis of the occupancy tree node is encoded & the node is a non-leaf node, or planarEligibleKOctreeDepth corresponding to the i-th node-layer is 0. In this case, the j-th node is not encoded using the planar encoding mode, and whether the j-th node is eligible for the point location direct-encoding-mode can be determined.

When the node is eligible for the point location direct-encoding-mode, operations at S310 are executed next. When the node is not eligible for the point location direct-encoding-mode, operations at S312 are executed next.

At S310, directly encode location information of a point(s) in the node.

Exemplarily, the number of points in the j-th node is n, where n is a positive integer.

At S311, when planarEligibleKOctreeDepth=0, numPointsCodedByIdcm+=n, i.e., accumulation update is performed on the value of numPointsCodedByIdem according to the number n of points in the j-th node.

At S312, encode occupancy information of 8 child nodes of the node.

Exemplarily, when the j-th node is not encoded using the point location direct-encoding-mode, an occupancy bit encoding mode may be used for the node, that is, the occupancy information of the 8 child nodes of the node is encoded. Exemplarily, the number of occupied child nodes among the 8 child nodes is m, where m≤8 and m is a positive integer. Here, an occupied child node refers to a child node whose occupancy bit is non-empty (for example, 1).

At S313, when planarEligibleKOctreeDepth=0, numSubnodes+=m, that is, accumulation update is performed on the value of numSubnodes according to the number m of occupied child nodes among the 8 child nodes of the j-th node.

At S314, whether all nodes in the current i-th layer have been processed?

In a case where a node in the current i-th layer has not yet been processed, operations at S315 are executed. In a case where all nodes in the current i-th layer have been processed, operations at S316 are executed.

At S315, j=j+1.

After the operations at S315, the process proceeds to operations at S305 to read a next node, and performs operations at S305 to S313 on the next node.

In some embodiments, after multiple cycles of the operations at S305 to S313, all nodes in the i-th layer can be processed. In this case, when planarEligibleKOctreeDepth=0, accumulation update of the value of numSubnodes corresponding to the i-th layer can be realized, and when planarEligibleKOctreeDepth=1, determine whether all layers have been processed, and operations at S302 are executed.

At S316, calculate realDensity-(numPoints-numPointsCodedByIdcm)/numSubnodes.

Here, realDensity represents the real point cloud density of the (i+1)-th layer. In some embodiments, the real point cloud density may also be referred to as the point cloud density without limitation.

At S317, whether realDensity<1.3 is satisfied.

If the real point cloud density realDensity of the (i+1)-th layer is less than 1.3, then operations at S318 will be executed next. Otherwise, if the real point cloud density realDensity of the (i+1)-th layer is greater than or equal to 1.3, then operations at S318 will be executed next.

Here, 1.3 is an example of a preset threshold. Optionally, the preset threshold may be greater than or equal to 1. In some embodiments, the preset threshold may be less than a certain value, for example, less than 2, 3, or the like, which is not limited herein.

It may be noted that in embodiments of the disclosure, the preset threshold may be changed. For example, the preset threshold is adjusted to be smaller, so that a determining condition for the planar encoding mode is much stricter. Alternatively, the preset threshold is adjusted to be greater, so that the determining condition for the planar encoding mode is much looser.

At S318, planarEligibleKOctreeDepth=1 and generate planar_mode_min_octree_depth_minus1=i+1.

Planar_mode_min_octree_depth_minus1 represents the planar mode enable level.

That is to say, if the real point cloud density realDensity of the (i+1)-th layer is less than 1.3, the planar-encoding-mode eligibility corresponding to the (i+1)-th layer may be set to 1 (i.e., planarEligibleKOctreeDepth=1), that is, a node (such as each node) in the (i+1)-th layer satisfies planarEligibleKOctreeDepth=1.

It may be noted that, the real point cloud density realDensity of the (i+1)-th layer being less than 1.3 indicates that the average number of points in each node in the (i+1)-th layer is less than 1.3. In this case, in the (i+1)-th layer, the number of points in some nodes is less than 1.3, such as 1, and the number of points in other nodes is greater than or equal to 1.3, such as 2 or 3. It may be understood that, when the real point cloud density realDensity of the (i+1)-th layer is less than 1.3, it indicates that the number of points in most nodes in the (i+1)-th layer is 1. Those skilled in the art may appreciate that, when the number of points in a node is 1, only one of eight child nodes of the node is occupied by the point. That is, the one child node is located on the same plane in three coordinate axis directions, and thus the node can be encoded using the planar encoding mode. Therefore, the probability that nodes in the (i+1)-th layer are eligible for the planar encoding mode may be relatively high, so that planarEligibleKOctreeDepth of the (i+1)-th layer can be set to 1.

At S319, planarEligibleKOctreeDepth=0.

That is to say, if the real point cloud density realDensity of the (i+1)-th layer is greater than or equal to 1.3, the planar-encoding-mode eligibility corresponding to the (i+1)-th layer may be set to 0 (i.e., planarEligibleKOctreeDepth=0), that is, a node (such as each node) in the (i+1)-th layer satisfies planarEligibleKOctreeDepth=0.

It may be noted that, the real point cloud density realDensity of the (i+1)-th layer being greater than or equal to 1.3 indicates that the average number of points in each node in the (i+1)-th layer is greater than or equal to 1.3. In this case, in the (i+1)-th layer, the number of points in most nodes is greater than or equal to 1.3, such as 2, 3, 4, . . . , and the like, and the number of points in a few nodes may be less than 1.3, such as 1. It may be understood that, when the real point cloud density realDensity of the (i+1)-th layer is greater than or equal to 1.3, it indicates that the number of points in most nodes in the (i+1)-th layer is 2, 3, or 4. Those skilled in the art may appreciate that, when the number of points in a node is 3 or more, child nodes containing the 3 or more points are very likely to be not on the same plane, and thus the probability that the node is eligible for the planar encoding mode is relatively low. Therefore, the probability that nodes in the (i+1)-th layer are eligible for the planar encoding mode may be relatively low, so that planarEligibleKOctreeDepth of the (i+1)-th layer can be set to 0.

In embodiments of the disclosure, according to a real point cloud density of a node-layer of an octree, planar-encoding-mode eligibility corresponding to the node-layer is determined, which can be conducive to more accurately determining whether all nodes in the node-layer are eligible for the planar encoding mode, thereby increasing encoding performance gains.

At S320, whether all layers have been processed?

After processing of the i-th layer, if there is still another layer that has not been processed, operations at S321 will be executed. When all layers have been processed, planar_mode_min_octree_depth_minus1 is encoded and signalled into the bitstream for transmission to the decoding end (decoder), and the process may end, that is, encoding of the point cloud is finished.

At S321, i=i+1.

After the operations at S321, the process proceeds to the operations at S303 to the (i+1)-th layer of the octree, that is, operations at S303 to S319 are performed on nodes in the next layer. In other words, the nodes in the next layer are encoded.

It may be noted that, when the process proceeds from the operations at S321 to the operations at S303 and continues to encoding of the nodes in the next layer, the next layer is regarded as the current encoding layer, i.e., the i-th layer. In this case, the current numSubnodes needs to be initialized, that is, numSubnodes is initialized as 0. In other words, during encoding of the current i-th layer, the number of child nodes generated from nodes in the current i-th layer is determined according to the encoding of the current i-th layer. That is to say, numSubnodes corresponds to the number of child nodes generated from the nodes in the current encoding node-layer.

It may be further noted that, when the process proceeds from the operations at S321 to the operations at S303, the value of numPointsCodedByIdem remains unchanged. During execution of the operations at S303 to S319, the value of numPointsCodedByIdem may be updated according to the encoding of each node in the current encoding node-layer. That is to say, numPointsCodedByIdem corresponds to the number of points eligible for the point location direct-encoding-mode in the entire point cloud.

It may be further noted that, when the process proceeds from the operations at S321 to the operations at S303, the value of planarEligibleKOctreeDepth remains unchanged. During execution of the operations at S303 to S319, whether each node in the current encoding node-layer is encoded using the planar encoding mode may be determined according to the value of planarEligibleKOctreeDepth. In addition, the value of planarEligibleKOctreeDepth may be updated according to both numPointsCodedByIdem and numSubnodes corresponding to all processed nodes in the current encoding node-layer, that is, the value of planarEligibleKOctreeDepth corresponding to the next layer of the current encoding node-layer may be determined.

In some optional embodiments, the encoding end (such as the encoder) may transmit the number of points in the point cloud and related information of the octree structure, such as the number of layers and node information of each layer, to the decoding end (such as the decoder) together with the binary bitrate obtained through encoding. For example, the number of points in the point cloud and related information of the octree structure may be included in the header file for transmission, which is not limited in the disclosure.

Therefore, in embodiments of the disclosure, planar-encoding-mode eligibility corresponding to a node-layer of the tree structure for the geometry information of the point cloud is determined, and then whether a node (such as a first node) in the node-layer is encoded using the planar encoding mode is determined according to the planar-encoding-mode eligibility corresponding to the node-layer. In embodiments of the disclosure, by determining the planar-encoding-mode eligibility corresponding to the node-layer of the tree structure corresponding to the geometry information of the point cloud, the planar-encoding-mode eligibility does not need to be determined for each node in the tree structure, thereby reducing computation complexity of coding and also improving encoding gains. Moreover, only when the planar-encoding-mode eligibility corresponding to the current node-layer is the fourth preset value (planarEligibleKOctreeDepth=0), the encoder updates the number of points for which the point location direct-encoding-mode is used or the second number of occupied child nodes, for determination of planar-encoding-mode eligibility of the next node-layer. However, when the planar-encoding-mode eligibility corresponding to the current node-layer is the third preset value, instead of updating the number of points for which the point location direct-encoding-mode is used or the second number of occupied child nodes, the encoder may determine the planar-encoding-mode eligibility corresponding to the current node-layer as the planar-encoding-mode eligibility of the next node-layer, i.e., the third preset value. In this way, the computation complexity of the encoding process can be reduced.

It may be noted that in standardized texts, the decoding method and the encoding method provided in embodiments of the disclosure may be embodied as follows.

For the introduced parameter planar_mode_min_octree_depth_minus1 (planar mode enable level), octree_depth refers to a layer number of an octree, which takes a value from 1 to n, and octree_depth_minus1 refers to an octree level (a serial number), which takes a value from 0 to n−1, so that planar_mode_min_octree_depth_minus1 means the minimum octree depth level in which the planar mode starts to be enabled.

In embodiments of the disclosure, the planar_mode_min_octree_depth_minus1 parameter is placed in the geometry data unit header syntax as represented in Table 1 below.

TABLE 1

| geometry_data_unit_header( ) { | Descriptor |
|---|---|
| ... | |
| planar_mode_min_octree_depth_minus1 | ue(v) |

That is, ue(v): unsigned integer 0-th order Exp-Golomb-coded syntax element with the left bit first.

In embodiments of the disclosure, PlanarEligible[k] can be assigned a value directly according to planar_mode_min_octree_depth_minus1.

In addition, the maximum level occtree_depth_minus1 is also identified in the point cloud, so that during encoding, the encoder can use occtree_depth_minus1-i to identify a layer number for which the planar mode is used planar_mode_enabled_num_octree, and then the decoding end assign PlanarEligible[k] a value according to i>occtree_depth_minus1-planar_mode_enabled_num_octree, which is not limited in embodiments of the disclosure.

In embodiments of the disclosure, the planar mode enable flag of each node-layer may also be represented by a parameter and signalled into the bitstream, or when encoding of a slice is finished, plane mode enable flags of all node-layers may be encoded as a slice-level flag in the form of an array and then signalled into the bitstream in the form of a flag group, which is not limited in embodiments of the disclosure.

In addition, the parametric representation of the planar mode enable flag in the standard may also be represented in conjunction with planar_mode_min_octree_depth_minus1, which is not limited in embodiments of the disclosure.

It may be noted that the planar mode enable flag corresponding to each node-layer indicates, by different assigned values, whether planar mode coding can be used.

The planar mode enable flag may be directly generated or may be obtained by direct assignment using planarEligibleKOctreeDepth, which is not limited in embodiments of the disclosure.

It may be noted that the above parameters are compressed and transmitted using exponential-Golomb-coding.

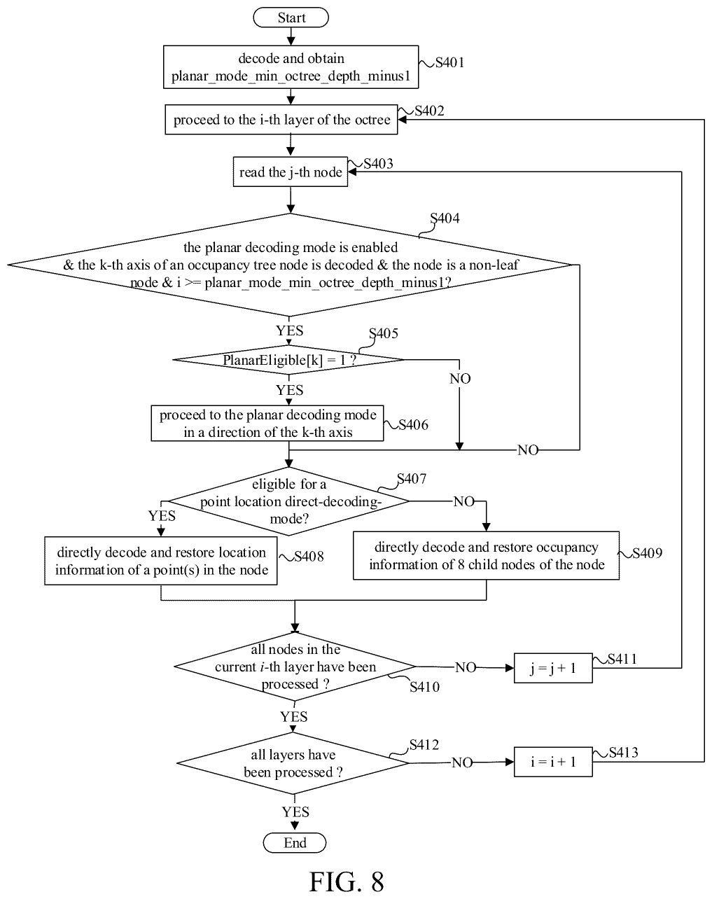

FIG. 8 is a schematic flowchart of a decoding method provided in embodiments of the disclosure. The decoding method is applicable to the decoder 200 illustrated in FIG. 4. For example, a geometry bitstream and attribute bitstream of a point cloud may be input into the decoder 200, and thus the point cloud can be decoded. As illustrated in FIG. 8, a process that the decoder decodes a planar mode enable level is taken as an example for description, and the method 400 includes operations at S401 to S413

It may be understood that, FIG. 8 illustrates steps or operations of the decoding method, but these steps or operations are merely exemplary. Other operations or various modifications of respective operations in FIG. 8 can be implemented in embodiments of the disclosure. In addition, each step in FIG. 8 may be executed in an order different from that illustrated in FIG. 8, and not all the operations illustrated in FIG. 8 may be executed.

At S401, decode and obtain planar_mode_min_octree_depth_minus1.

In embodiments of the disclosure, the decoder may parse a bitstream to obtain a planar mode enable level corresponding to a slice, i.e., planar_mode_min_octree_depth_minus1.

At S402, proceed to the i-th layer of the octree, where 0≤i≥M, and i is an integer.

In some optional embodiments, after operations at S401 are executed, operations at S402 may be executed. In this case, i=0, i.e., proceed to decoding of the 0-th layer of the octree.

In some optional embodiments, after operations at S414 are executed, the operations at S403 may be executed. In this case, 0<i≤M, i.e., after decoding of that node-layer, proceed to decoding of a next node-layer of the node-layer.

At S403, read the j-th node, where 0≤j≤X, i is an integer, X represents the number of nodes in the i-th layer, and X is a positive integer.

At S404, whether the following are satisfied: the planar decoding mode is enabled & the k-th axis of an occupancy tree node is decoded & the node is a non-leaf node & i>=planar_mode_min_octree_depth_minus1.

That is, it is determined whether the j-th node satisfies the four conditions that the planar decoding mode is enabled, the k-th axis of the occupancy tree node is decoded, the node is a non-leaf node, and i>planar_mode_min_octree_depth_minus1.

When it is determined that the j-th node satisfies the four conditions that the planar decoding mode is enabled, the k-th axis of the occupancy tree node is decoded, the node is a non-leaf node, i>planar_mode_min_octree_depth_minus1, operations at S405 are executed next. When it is determined that the j-th node does not satisfy at least one of the conditions that the planar decoding mode is enabled, the k-th axis of the occupancy tree node is decoded, and the node is a non-leaf node, or when it is determined that the j-th node does not satisfy i>planar_mode_min_octree_depth_minus1, operations at S407 are executed next.

It may be noted that, at S406, whether the j-th node satisfies the three conditions that the planar decoding mode is enabled, the k-th axis of the occupancy tree node is decoded, and the node is a non-leaf node is taken as an example for illustration, but embodiments of the disclosure are not limited thereto. For example, in some embodiments, it may also be determined whether the j-th node satisfies at least one of the three conditions or other conditions, which is not limited in the disclosure.

At S405, whether PlanarEligible[k]=1 is satisfied.

PlanarEligible[k]=1 if i>planar_mode_min_octree_depth_minus1.

PlanarEligible[k]=0 if i≥planar_mode_min_octree_depth_minus1. In the above, PlanarEligible[k] represents planar-decoding-mode eligibility of the current node (i.e., the j-th node) in a direction of the k-th axis. Exemplarily, the planar-decoding-mode eligibility of the node may indicate whether the node can be decoded using the planar decoding mode. For example, when the planar-decoding-mode eligibility is 1, the node can be decoded using the planar decoding mode. When the planar-decoding-mode eligibility is 0, the node cannot be decoded using the planar decoding mode.

When PlanarEligible[k]=1, operations at S406 are executed next. When PlanarEligible[k]=0, operations at S407 are executed next.

At S406, proceed to the planar decoding mode in a direction of the k-th axis.

Specifically, in this case, the j-th node may be decoded using the planar decoding mode in the direction of the k-th axis.

At S407, eligible for the point location direct-decoding-mode?

In some optional embodiments, in a case where operations at S407 are executed after the operations at S406, the j-th node satisfies the three conditions that the planar decoding mode is enabled & the k-th axis of the occupancy tree node is decoded & the node is a non-leaf node, and i corresponding to the i-th node-layer satisfies i>planar_mode_min_octree_depth_minus1. In this case, after the j-th node is decoded using the planar decoding mode, whether the j-th node is eligible for the point location direct-decoding-mode can be determined.

In some optional embodiments, in a case where the operations at S407 are executed after operations at S404 or S406, the j-th node does not satisfy at least one of the conditions that the planar decoding mode is enabled & the k-th axis of the occupancy tree node is decoded & the node is a non-leaf node, or i corresponding to the i-th node-layer does not satisfy i>planar_mode_min_octree_depth_minus1. In this case, the j-th node is not decoded using the planar decoding mode, and whether the j-th node is eligible for the point location direct-decoding-mode can be determined.

When the node is eligible for the point location direct-decoding-mode, operations at S408 are executed next. When the node is not eligible for the point location direct-decoding-mode, operations at S409 are executed next.

At S408, directly decode and restore location information of a point(s) in the node.

Exemplarily, the number of points in the j-th node is n, where n is a positive integer.

At S409, decode and restore occupancy information of 8 child nodes of the node.

Exemplarily, when the j-th node is not decoded using the point location direct-decoding-mode, an occupancy bit decoding mode may be used for the node, that is, the occupancy information of the 8 child nodes of the node is decoded. Exemplarily, the number of occupied child nodes among the 8 child nodes is m, where m≤8 and m is a positive integer. Here, an occupied child node refers to a child node whose occupancy bit is non-empty (for example, 1).

At S410, whether all nodes in the current i-th layer have been processed?

In a case where a node in the current i-th layer has not yet been processed, operations at S411 are executed. In a case where all nodes in the current i-th layer have been processed, operations at S412 are executed.

At S411, j=j+1.

After the operations at S411, the process proceeds to operations at S403 to read a next node, and performs operations at S403 to S410 on the next node.

In some embodiments, after multiple cycles of the operations at S403 to S410, all nodes in the i-th layer can be processed.

At S412, whether all layers have been processed?

After processing of the i-th layer, if there is still another layer that has not been processed, operations at S413 will be executed. When all layers have been processed, the process may end, that is, decoding of the point cloud is finished.

At S413, i=i+1.

After the operations at S413, the process proceeds to the operations at S402 to the (i+1)-th layer of the octree, that is, operations at S402 to S412 are performed on nodes in the next layer. In other words, the nodes in the next layer are decoded.

It may be noted that, when the process proceeds from the operations at S413 to the operations at S402 and continues to decoding of the nodes in the next layer, the next layer is regarded as the current decoding layer, i.e., the i-th layer.

It may be understood that the decoder can directly obtain the planar mode enable level by parsing the bitstream. Therefore, the computation on whether the current node-layer proceeds to the planar decoding mode at the decoder side can be reduced, and the computation complexity can be reduced.

Table 2 and Table 3 each illustrate an example of the effect of the encoding method of embodiments of the disclosure with respect to the related art. Test sequences may include multiple test picture sequences, such as Cat1-A average, Cat1-B average, Cat3-fused average, and Cat3-frame average, etc. There are two error computation methods for geometry coding bitrate (BD-rate), which output computation errors D1 and D2 respectively. D1 represents a point-to-point geometry information error between a point in an original point cloud and a corresponding point in a reconstructed point cloud, and D2 represents a point-to-plane geometry information error between a point in the reconstructed point cloud and a plane for a corresponding point in the original point cloud, where the plane is related to a normal vector of the corresponding point.

Table 2 illustrates BD-rates obtained in the encoding method provided in embodiments of the disclosure under lossy compression of geometry information. The BD-rate represents a coding-bitrate saving percentage of the encoding method of embodiments of the disclosure with respect to the related art, under the same coding quality, where a negative BD-rate represents saved coding bitrates and a positive BD-rate represents increased coding bitrates. As can be seen from Table 2, for most of the test sequences, the use of the encoding method of embodiments of the disclosure can save coding bitrates.

TABLE 2

| | Geometry BD-TotalRate (%) | |
|---|---|---|
| Test sequence | D1 | D2 |
| Cat1-A average | −0.1% | −0.1% |
| Cat1-B average | −0.3% | −0.3% |
| Cat3-fused average | 0.5% | 0.5% |
| Cat3-frame average | −0.7% | −0.7% |
| Overall average | −0.2% | −0.2% |

| | |
|---|---|
| Avg. Enc Time [%] | 97% |
| Avg. Dec Time [%] | 98% |

Table 3 illustrates bpip ratios obtained in the encoding method provided in embodiments of the disclosure under lossless compression of geometry information. The bpip ratio represents the percentage of the coding bitrate of the embodiments of the disclosure in the coding bitrate of the related art, with no loss of point cloud quality, where the lower the numerical value of bpip ratio, the greater the bitrate savings in the encoding method of the embodiments of the disclosure. As can be seen from Table 3, for most of the test sequences, the use of the encoding method of embodiments of the disclosure can save coding bitrates.

TABLE 3

| | Geometry bpip ratio (%) |
|---|---|
| Test sequence | D1 |
| Cat1-A average | 97.2% |
| Cat1-B average | 99.8% |
| Cat3-fused average | 100.8% |
| Cat3-frame average | 99.9% |
| Overall average | 99.6% |
| Avg. Enc Time [%] | 95% |
| Avg. Dec Time [%] | 94% |

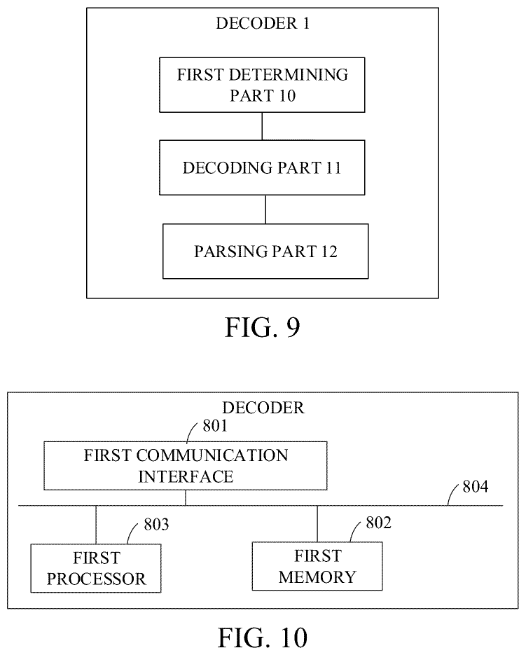

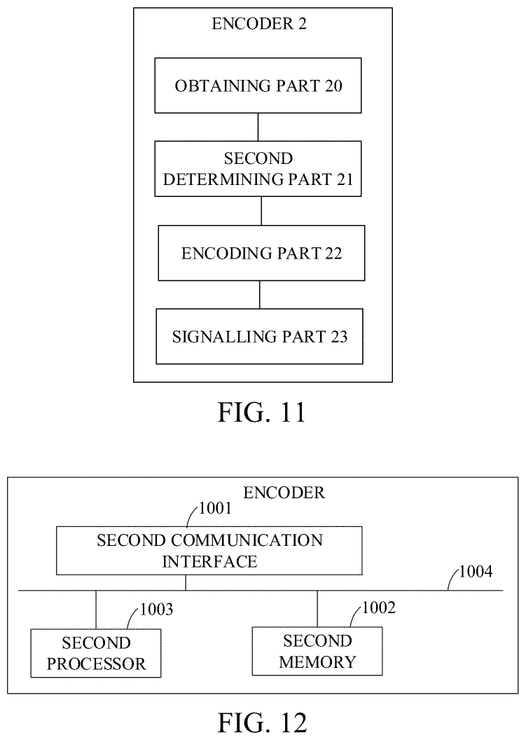

Based on the same inventive concept as the previous embodiments, refer to FIG. 9, which is a schematic structural diagram illustrating a decoder 1 provided in embodiments of the disclosure. The decoder 1 may include a first determining part 10 and a decoding part 11. The first determining part 10 is configured to determine a planar mode enable flag of a point cloud and geometry encoding information of the point cloud. The decoding part 11 is configured to decode a node in a current node-layer using a planar decoding mode when a planar mode enable flag corresponding to a level of the current node-layer is a first preset value, during decoding of geometry encoding information of the node in the current node-layer.

In some embodiments of the disclosure, the decoder 1 further includes a parsing part 12. The parsing part 12 is configured to obtain a planar mode enable level of the point cloud by parsing a bitstream. The planar mode enable level represents a minimum depth level in which a planar mode starts to be enabled.

In some embodiments of the disclosure, the first determining part 10 is further configured to determine that the planar mode enable flag corresponding to the level of the current node-layer is the first preset value, when the level of the current node-layer is greater than or equal to the planar mode enable level.

In some embodiments of the disclosure, the decoder 1 further includes a parsing part 12. The parsing part 12 is configured to obtain the planar mode enable flag corresponding to the level of the current node-layer by parsing a bitstream.

In some embodiments of the disclosure, the first determining part 10 is further configured to determine that the planar mode enable flag of the point cloud is a second preset value when the level of the current node-layer is less than the planar mode enable level, during decoding of the node in the current node-layer.

In some embodiments of the disclosure, the decoding part 11 is further configured to decode the node in the current node-layer using either a point location direct-decoding-mode or an occupancy bit decoding mode.

In some embodiments of the disclosure, the first determining part 10 is further configured to determine that the node in the current node-layer satisfies at least one of: the planar decoding mode being enabled for the node, a k-th axis of an occupancy tree node corresponding to the node being decoded, or the node being a non-leaf node in a tree structure, before decoding the node in the current node-layer using the planar decoding mode when the planar mode enable flag corresponding to the level of the current node-layer is the first preset value.

In some embodiments of the disclosure, the decoding part 11 is further configured to allow the node to be decoded using the planar decoding mode in a direction of a k-th axis when the planar mode enable flag corresponding to the level of the current node-layer is the first preset value, where k represents a coordinate component.

In some embodiments of the disclosure, the decoding part 11 is further configured to disallow the node to be decoded using the planar decoding mode in a direction of a k-th axis when the planar mode enable flag corresponding to the level of the current node-layer is a second preset value.

In some embodiments of the disclosure, whether the node is decoded using the planar decoding mode in the direction of the k-th axis is indicated by planar-decoding-mode eligibility of the k-th axis of the node.

It may be understood that since the planar mode enable flag can be obtained at the time of decoding, whether the current node-layer is decoded using the planar decoding mode can be determined according to the planar mode enable flag, which simplifies the process of calculating the planar-coding-mode eligibility of the current node-layer at the decoder end, thereby reducing the computation complexity of decoding and also improving the decoding gains.

It may be understood that in embodiments, the “part” may be a part of a circuit, a part of a processor, a part of a program or software, and the like, and definitely may also be a module, and may also be non-modular. Furthermore, each component in embodiments may be integrated into one processing unit, or each unit may exist alone physically, or two or more units may be integrated into one unit. The integrated unit may be implemented in a form of hardware, and may also be implemented in a form of a software functional module.

If the integrated unit is implemented as a software functional module and sold or used as standalone products, it may be stored in a computer-readable storage medium. Based on such an understanding, the essential technical solutions of embodiments, or the portion that contributes to the related art, or all or part of the technical solutions may be embodied as software products. The computer software products can be stored in a storage medium and may include multiple instructions that, when executed, can cause a computer device (may be a personal computer, a server, a network device, etc.) or a processor to perform some or all operations of the methods described in embodiments. The storage medium may include various kinds of media that can store program codes, such as a universal serial bus (USB) flash disk, a read-only memory (ROM), a random access memory (RAM), a magnetic disk, an optical disk, etc.

Therefore, a computer-readable storage medium is provided in embodiments of the disclosure. The computer-readable storage medium is configured to store computer programs. The computer programs are executed by a first processor to implement the decoding method in the foregoing embodiments.

Based on the composition of the decoder above and the computer storage medium, refer to FIG. 10, which illustrates a specific hardware structure of a decoder provided in embodiments of the disclosure. The decoder may include a first communication interface 801, a first memory 802, and a first processor 803, where these components are coupled together via a first bus system 804. It may be understood that the first bus system 804 is configured for connection and communication between these components. In addition to a data bus, the first bus system 804 further includes a power bus, a control bus, and a status signal bus. However, for the convenience of description, various buses are marked as the first bus system 804 in FIG. 10.

The first communication interface 801 is configured for signal reception and transmission during information transmission and reception with other external network elements. The first memory 802 is configured to store computer programs that are executable on the first processor 803. The first processor 803 is configured to perform the decoding method performed by the decoder when running the computer programs.

It may be understood that, the first memory 802 in embodiments of the disclosure may be a volatile memory or a non-volatile memory, or may include both the volatile memory and the non-volatile memory. The non-volatile memory may be an ROM, a programmable ROM (PROM), an erasable PROM (EPROM), an electrically EPROM (EEPROM), or a flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDRSDRAM), an enhanced SDRAM (ESDRAM), a synclink DRAM (SLDRAM), and a direct rambus RAM (DRRAM). The first memory 802 in the system and the method described in the disclosure is intended to include, but is not limited to, these and any other suitable types of memory.

The first processor 803 may be an integrated circuit chip with signal processing capabilities. During implementation, each step of the foregoing method may be completed by an integrated logic circuit of hardware in the first processor 803 or an instruction in the form of software. The first processor 803 may be a general-purpose processor, a digital signal processor (DSP), an application specific integrated circuit (ASIC), a field programmable gate array (FPGA), or other programmable logic devices, discrete gates or transistor logic devices, discrete hardware components, etc. The first processor 803 can implement or execute the methods, steps, and logic block diagrams disclosed in embodiments of the disclosure. The general-purpose processor may be a microprocessor, or the processor may be any conventional processor or the like. The steps of the method disclosed in embodiments of the disclosure may be directly implemented as a hardware decoding processor, or may be performed by hardware and software modules in the decoding processor. The software module may be located in a storage medium such as a random memory, a flash, an ROM, a PROM, an electrically erasable programmable memory, or a register. The storage medium is located in the first memory 802. The first processor 803 reads information in the first memory 802, and completes the steps of the decoding method described above with the hardware thereof.

It may be understood that the embodiments described herein may be implemented in hardware, software, firmware, middleware, microcode, or combinations thereof. For hardware implementation, the processing unit may be implemented in one or more ASICs, digital signal processors (DSPs), digital signal processing devices (DSPDs), programmable logic devices (PLDs), FPGAs, general-purpose processors, controllers, micro-controllers, microprocessors, other electronic units for performing the functions in the disclosure, or a combination thereof. For software implementation, the techniques described in the disclosure may be implemented by modules (e. g., procedures, functions, etc.) that perform the functions described herein. The software codes may be stored in the memory and executed by the processor. The memory may be implemented in the processor or external to the processor.

Based on the same inventive concept as the previous embodiments, refer to FIG. 10, which is a schematic structural diagram illustrating an encoder 2 provided in embodiments of the disclosure. The encoder 2 may include an obtaining part 20, a second determining part 21, and an encoding part 22. The obtaining part 20 is configured to obtain geometry information of a point cloud. The second determining part 21 is configured to determine planar-encoding-mode eligibility corresponding to a current node-layer corresponding to the geometry information. The encoding part 22 is configured to determine that a node in the current node-layer is encoded using a planar encoding mode and generate a planar mode enable flag corresponding to a level of the current node-layer, when the planar-encoding-mode eligibility corresponding to the current node-layer is a third preset value.

In some embodiments of the disclosure, the second determining part 21 is further configured to determine that the planar-encoding-mode eligibility corresponding to the current node-layer is the third preset value, when planar-encoding-mode eligibility corresponding to a previous node-layer of the current node-layer is the third preset value.

In some embodiments of the disclosure, the encoder 2 further includes a signalling part 23. The signalling part 23 is configured to signal the planar mode enable flag corresponding to the level of the current node-layer into a bitstream.

In some embodiments of the disclosure, the second determining part 21 is further configured to, after determining the planar-encoding-mode eligibility corresponding to the current node-layer corresponding to the geometry information, signal the level of the current node-layer into a bitstream as a planar mode enable level when the planar-encoding-mode eligibility corresponding to the current node-layer is the third preset value and the planar-encoding-mode eligibility corresponding to the previous node-layer of the current node-layer is a fourth preset value. Optionally, the second determining part 21 is further configured to determine that the node in the current node-layer is encoded using the planar encoding mode and signal the level of the current node-layer into the bitstream as the planar mode enable level, when the planar-encoding-mode eligibility corresponding to the current node-layer is the third preset value.

In some embodiments of the disclosure, the second determining part 21 is further configured to generate the planar mode enable flag corresponding to the level of the current node-layer as a first preset value when the level of the current node-layer is taken as the planar mode enable level.

In some embodiments of the disclosure, the second determining part 21 is further configured to: determine a point cloud density of the current node-layer when planar-encoding-mode eligibility corresponding to a previous node-layer of the current node-layer is a fourth preset value; and determine the planar-encoding-mode eligibility corresponding to the current node-layer according to the point cloud density of the current node-layer.

In some embodiments of the disclosure, the second determining part 21 is further configured to: determine, in a node-layer(s) prior to the current node-layer in the point cloud, a number of points for which a point location direct-encoding-mode is used; determine a first number of occupied child nodes corresponding to a previous node-layer of the current node-layer, where the first number of occupied child nodes is a total number of occupied child nodes of a node(s) that is encoded using an occupancy bit encoding mode in the previous node-layer; and determine the point cloud density of the current node-layer according to a number of points in the point cloud, the number of points for which the point location direct-encoding-mode is used, and the first number of occupied child nodes.

In some embodiments of the disclosure, the second determining part 21 is further configured to: determine that the planar-encoding-mode eligibility corresponding to the current node-layer is the third preset value, when the point cloud density is less than a preset threshold; and determine that the planar-encoding-mode eligibility corresponding to the current node-layer is the fourth preset value, when the point cloud density is greater than or equal to the preset threshold.

In some embodiments of the disclosure, the preset threshold is greater than or equal to 1.

In some embodiments of the disclosure, the encoding part 22 is configured to encode the node in the current node-layer using either a point location direct-encoding-mode or an occupancy bit encoding mode, after determining, when the planar-encoding-mode eligibility corresponding to the current node-layer is the third preset value, that the node in the current node-layer is encoded using the planar encoding mode, or when the planar-encoding-mode eligibility corresponding to the current node-layer is a fourth preset value.

In some embodiments of the disclosure, the second determining part 21 is further configured to update a value of the number of points for which the point location direct-encoding-mode is used, when the planar-encoding-mode eligibility corresponding to the current node-layer is the fourth preset value and the node in the current node-layer is encoded using the point location direct-encoding-mode.

In some embodiments of the disclosure, the second determining part 21 is further configured to update a second number of occupied child nodes corresponding to the current node-layer, when the planar-encoding-mode eligibility corresponding to the current node-layer is the fourth preset value and the node in the current node-layer is encoded using the occupancy bit encoding mode. The second number of occupied child nodes is a number of occupied child nodes of a node(s) that is encoded using the occupancy bit coding mode in the current node-layer.

In some embodiments of the disclosure, the encoding part 22 is configured to determine that the node is encoded using the planar encoding mode in a direction of a k-th axis, when the planar-encoding-mode eligibility corresponding to the current node-layer is the third preset value and the node satisfies at least one of the following conditions. k represents a coordinate component. These conditions include: the planar encoding mode being enabled for the node, the k-th axis of an occupancy tree node corresponding to the node being encoded, or the node being a non-leaf node.

It may be understood that the encoder determines the planar-encoding-mode eligibility corresponding to the node-layer in the tree structure corresponding to the geometry information of the point cloud, so that a process of determining planar-encoding-mode eligibility for each node in the tree structure can be omitted, thereby reducing computation complexity of encoding and also improving encoding gains.

Based on the composition of the encoder above and the computer storage medium, refer to FIG. 12, which illustrates a specific hardware structure of an encoder provided in embodiments of the disclosure. The encoder may include a second communication interface 1001, a second memory 1002, and a second processor 1003, where these components are coupled together via a second bus system 1004. It may be understood that the second bus system 1004 is configured for connection and communication between these components. In addition to a data bus, the second bus system 1004 further includes a power bus, a control bus, and a status signal bus. However, for the convenience of description, various buses are marked as the second bus system 1004 in FIG. 12.

The second communication interface 1001 is configured for signal reception and transmission during information transmission and reception with other external network elements. The second memory 1002 is configured to store computer programs that are executable on the second processor 1003. The second processor 1003 is configured to perform the encoding method performed by the encoder when running the computer programs.

It may be understood that the hardware functions of the second memory 1002 are similar to those of the first memory 802, and the hardware functions of the second processor 1003 are similar to those of the first processor 803, which will not be repeated herein.

It may be noted that, in the disclosure, the terms “include”, “comprise”, “have”, or any other variation thereof are intended to cover a non-exclusive inclusion, so that a process, a method, an article, or an apparatus including a series of elements not only includes those elements, but also includes other elements not explicitly listed, or also includes elements inherent to such process, method, article, or apparatus. An element limited by the sentence “including a . . . ” does not exclude that there are other same elements in the process, method, article, or apparatus that includes the element, unless there are more limitations.

The above serial numbers of embodiments of the disclosure are only for description, and do not represent the preference of the embodiments.

The methods disclosed in the method embodiments provided by the disclosure may be combined arbitrarily without conflicts to obtain new method embodiments. The features disclosed in the product embodiments of the disclosure may be combined arbitrarily without conflicts to obtain new product embodiments. The features disclosed in the several method or device embodiments of the disclosure may be combined arbitrarily without conflicts to obtain new method embodiments or new device embodiments.

The foregoing elaborations are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

### INDUSTRIAL APPLICABILITY

In embodiments of the disclosure, the method is applicable to a decoder and includes the following. A planar mode enable flag of a point cloud and geometry encoding information of the point cloud are determined. During decoding of geometry encoding information of a node in a current node-layer, the node in the current node-layer is decoded using a planar decoding mode when a planar mode enable flag corresponding to a level of the current node-layer is a first preset value. In this way, since the planar mode enable flag can be obtained at the time of decoding, whether the current node-layer is decoded using the planar decoding mode can be determined according to the planar mode enable flag, which simplifies the process of calculating the planar-coding-mode eligibility of the current node-layer at the decoder end, thereby reducing the computation complexity of decoding and also improving the decoding gains.

The method is further applicable to an encoder and includes the following. Geometry information of a point cloud is obtained. Planar-encoding-mode eligibility corresponding to a current node-layer is determined. When the planar-encoding-mode eligibility corresponding to the current node-layer is a third preset value, it is determined that a node in the current node-layer is encoded using a planar encoding mode, and a planar mode enable flag corresponding to a level of the current node-layer is generated. In this way, the encoder determines the planar-encoding-mode eligibility corresponding to the current node-layer in the point cloud corresponding to the geometry information, so that a process of determining planar-encoding-mode eligibility for each node can be omitted, thereby reducing computation complexity of encoding and also improving encoding gains.

What is claimed is:

1. A decoding method, applied to a decoder and comprising:
determining a planar mode enable flag of a point cloud and geometry encoding information of the point cloud; and
during decoding of geometry encoding information of a node in a current node-layer, decoding the node in the current node-layer using a planar decoding mode when a planar mode enable flag corresponding to a level of the current node-layer is a first preset value.

2. The method of claim 1, further comprising:
obtaining a planar mode enable level of the point cloud by parsing a bitstream, wherein the planar mode enable level represents a minimum depth level in which a planar mode starts to be enabled.

3. The method of claim 2, wherein determining the planar mode enable flag of the point cloud comprises:
when the level of the current node-layer is greater than or equal to the planar mode enable level, determining that the planar mode enable flag corresponding to the level of the current node-layer is the first preset value.

4. The method of claim 1, wherein determining the planar mode enable flag of the point cloud comprises:
obtaining the planar mode enable flag corresponding to the level of the current node-layer by parsing a bitstream.

5. The method of claim 2, further comprising:
during decoding of the node in the current node-layer, determining that the planar mode enable flag of the point cloud is a second preset value when the level of the current node-layer is less than the planar mode enable level.

6. The method of claim 1, further comprising:
decoding the node in the current node-layer using either a point location direct-decoding-mode or an occupancy bit decoding mode.

7. The method of claim 1, wherein before decoding the node in the current node-layer using the planar decoding mode when the planar mode enable flag corresponding to the level of the current node-layer is the first preset value, the method further comprises:
determining that the node in the current node-layer satisfies at least one of:
the planar decoding mode being enabled for the node;
a k-th axis of an occupancy tree node corresponding to the node being decoded; or
the node being a non-leaf node in a tree structure.

8. The method of claim 1, wherein decoding the node in the current node-layer using the planar decoding mode when the planar mode enable flag corresponding to the level of the current node-layer is the first preset value comprises:
when the planar mode enable flag corresponding to the level of the current node-layer is the first preset value, allowing the node to be decoded using the planar decoding mode in a direction of a k-th axis, wherein k represents a coordinate component.

9. The method of claim 1, further comprising:
when the planar mode enable flag corresponding to the level of the current node-layer is a second preset value, disallowing the node to be decoded using the planar decoding mode in a direction of a k-th axis.

10. The method of claim 8, wherein whether the node is decoded using the planar decoding mode in the direction of the k-th axis is indicated by planar-decoding-mode eligibility of the k-th axis of the node.

11. An encoding method, applied to an encoder and comprising:
obtaining geometry information of a point cloud;
determining planar-encoding-mode eligibility corresponding to a current node-layer corresponding to the geometry information; and
when the planar-encoding-mode eligibility corresponding to the current node-layer is a third preset value, determining that a node in the current node-layer is encoded using a planar encoding mode, and generating a planar mode enable flag corresponding to a level of the current node-layer.

12. The method of claim 11, wherein determining the planar-encoding-mode eligibility corresponding to the current node-layer corresponding to the geometry information comprises:
when planar-encoding-mode eligibility corresponding to a previous node-layer of the current node-layer is the third preset value, determining that the planar-encoding-mode eligibility corresponding to the current node-layer is the third preset value.

13. The method of claim 11, further comprising:
signalling the planar mode enable flag corresponding to the level of the current node-layer into a bitstream.

14. The method of claim 11, wherein after determining the planar-encoding-mode eligibility corresponding to the current node-layer corresponding to the geometry information, the method further comprises:
when the planar-encoding-mode eligibility corresponding to the current node-layer is the third preset value and the planar-encoding-mode eligibility corresponding to a previous node-layer of the current node-layer is a fourth preset value, signalling the level of the current node-layer into a bitstream as a planar mode enable level; or
when the planar-encoding-mode eligibility corresponding to the current node-layer is the third preset value, determining that the node in the current node-layer is encoded using the planar encoding mode, and signalling the level of the current node-layer into the bitstream as the planar mode enable level.

15. The method of claim 11, wherein determining the planar-encoding-mode eligibility corresponding to the current node-layer corresponding to the geometry information comprises:
when planar-encoding-mode eligibility corresponding to a previous node-layer of the current node-layer is a fourth preset value, determining a point cloud density of the current node-layer; and
determining the planar-encoding-mode eligibility corresponding to the current node-layer according to the point cloud density of the current node-layer.

16. The method of claim 15, wherein determining the point cloud density of the current node-layer comprises:
determining, in a node-layer prior to the current node-layer in the point cloud, a number of points for which a point location direct-encoding-mode is used;
determining a first number of occupied child nodes corresponding to a previous node-layer of the current node-layer, wherein the first number of occupied child nodes is a total number of occupied child nodes of a node that is encoded using an occupancy bit encoding mode in the previous node-layer; and
determining the point cloud density of the current node-layer according to a number of points in the point cloud, the number of points for which the point location direct-encoding-mode is used, and the first number of occupied child nodes.

17. The method of claim 16, wherein determining the planar-encoding-mode eligibility corresponding to the current node-layer according to the point cloud density of the current node-layer comprises:
when the point cloud density is less than a preset threshold, determining that the planar-encoding-mode eligibility corresponding to the current node-layer is the third preset value; and
when the point cloud density is greater than or equal to the preset threshold, determining that the planar-encoding-mode eligibility corresponding to the current node-layer is the fourth preset value,
wherein the preset threshold is greater than or equal to 1.

18. The method of claim 11, wherein when the planar-encoding-mode eligibility corresponding to the current node-layer is a fourth preset value, or after determining that the node in the current node-layer is encoded using the planar encoding mode when the planar-encoding-mode eligibility corresponding to the current node-layer is the third preset value, the method further comprises:
encoding the node in the current node-layer using either a point location direct-encoding-mode or an occupancy bit encoding mode.

19. The method of claim 11, wherein when the planar-encoding-mode eligibility corresponding to the current node-layer is the third preset value, determining that the node in the current node-layer is encoded using the planar encoding mode comprises:
determining that the node is encoded using the planar encoding mode in a direction of a k-th axis, when the planar-encoding-mode eligibility corresponding to the current node-layer is the third preset value and the node satisfies at least one of:
the planar encoding mode being enabled for the node;
the k-th axis of an occupancy tree node corresponding to the node being encoded; or
the node being a non-leaf node;
wherein k represents a coordinate component.

20. A decoder, comprising:
a processor and a memory storing a computer program which, when executed by the processor, causes the decoder to:
determine a planar mode enable flag of a point cloud and geometry encoding information of the point cloud; and
during decoding of geometry encoding information of a node in a current node-layer, decode the node in the current node-layer using a planar decoding mode when a planar mode enable flag corresponding to a level of the current node-layer is a first preset value.
